(19) United States
(12) Patent Application Publication
(10) Pub. No.: US 2011/0211233 A1
(43) Pub. Date: Sep. 1, 2011

(54) IMAGE PROCESSING DEVICE, IMAGE PROCESSING METHOD AND COMPUTER PROGRAM

(75) Inventor: Jun YOKONO, Tokyo (JP)

(73) Assignee: Sony Corporation, Tokyo (JP)

(21) Appl. No.: 13/022,933

(22) Filed: Feb. 8, 2011

(30) Foreign Application Priority Data
Mar. 1, 2010 (JP) 2010-043657

(51) Int. Cl. H04N 1/04

(52) U.S. Cl. 358/474

(57) ABSTRACT

An image processing device includes a scanning unit configured to scan a search window on an image to be detected, and a discrimination unit configured to apply one or more rectangle filters for detecting a desired object to an image of the search window at each scan position so as to calculate one or more rectangle features and to discriminate whether or not the object is detected based on the obtained one or more rectangle features. The scanning unit generates integral images corresponding to a size of the search window at every scan position and holds the integral images in a predetermined memory buffer, and the discrimination unit calculates the rectangle features with respect to the image of the search window at each scan position using the integral images held in the memory buffer.

### BACKGROUND OF THE INVENTION

1. Field of the Invention

The present invention relates to an image processing device and image processing method and a computer program which detect a desired object from an image using a rectangle filter and, more particularly, to an image processing method, an image processing device and image processing method and a computer program which reduce a memory buffer amount when calculating a rectangle feature using an integral image.

2. Description of the Related Art

When object detection such as face recognition is performed, a filter is used as a unit for extracting a feature amount of an image. If such a filter is used alone, it may serve as only a “weak discriminator (or a weak learner)”, which attributes slightly better than random and indicates whether or not a desired object (for example, a subject's face, or a smiling face) may be recognized from an image, for example, using a positive/negative sign. However, by linearly coupling a plurality of weak discriminators, it is possible to build a stronger discriminator (for example, see Japanese Unexamined Patent Application Publication No. 2009-140369).

As an individual weak discriminator, a rectangle filter or a Haar-like filter based on the Haar basis is used. The rectangle filter is a simple structure including a combination of black rectangles and white rectangles. The weak discriminator determines whether or not an object is detected by a rectangle feature obtained by superposing a rectangle filter on a search region, that is, depending on whether a difference between a sum of luminance values within a region corresponding to the black rectangle and a sum of luminance values within a region corresponding to the white rectangle is greater than a threshold.

In order to rapidly calculate the rectangle feature, a method of using an integral image which is an intermediate image is proposed (for example, see Paul Viola & Michael Jones “Robust Real-Time Face Detection” (International Journal of Computer Vision, 2004)). The integral image is an image representing a pixel point of an input image by a cumulative sum of an image feature amount, that is, an integral pixel value. For example, if an input image is a luminance image, an integral image is an image representing an integral pixel value of each pixel point (x, y) within the input image by a luminance integral value obtained by integrating luminance values of all pixel points within a rectangle having an original point (0, 0) and the pixel point (x, y) of the input image as apexes on a diagonal line. If an integral image is used, it is possible to simply calculate a sum of luminance values of a certain rectangle region within an image. Accordingly, in the case of a rectangle filter (primary differential filter) including one white rectangle and one black rectangle, if a sum of luminance values of the region corresponding to the white rectangle and a sum of luminance values of the region corresponding to the black rectangle are rapidly calculated using the integral image, a rectangle feature may be obtained by subtracting the latter sum from the former sum.

If the integral image is used when scanning the rectangle filter on the input image, it is possible to rapidly calculate the rectangle feature. However, since a memory buffer having the same size as the input image is necessary in order to maintain the generated integral image, for example, a problem occurs in hardware mounting. For example, if a Video Graphic Array (VGA) image including 640×480 pixels is processed, a 307.2-kilobyte buffer (in the case of 8 bits) for an input image and a 1,228,800-byte (1.2-megabyte: if 1 pixel is represented by 4 bytes) buffer for an integral image are necessary.

### SUMMARY OF THE INVENTION

It is desirable to provide an excellent image processing device and image processing method, which is able to suitably detect a desired object from an image using a rectangle filter, and a computer program.

It is desirable to provide an excellent image processing device and image processing method, which is able to reduce a memory buffer amount when calculating a rectangle feature using an integral image, and a computer program.

According to an embodiment of the present invention, there is provided an image processing device including: a scanning unit configured to scan a search window on an image to be detected; and a discrimination unit configured to apply one or more rectangle filters for detecting a desired object to an image of the search window at each scan position so as to calculate one or more rectangle features and to discriminate whether or not the object is detected based on the obtained one or more rectangle features, wherein the scanning unit generates integral images corresponding to a size of the search window at every scan position and holds the integral images in a predetermined memory buffer, and wherein the discrimination unit calculates the rectangle features with respect to the image of the search window at each scan position using the integral images held in the memory buffer.

The scanning unit may discard integral images of a region, which is not necessary at a subsequent scan position, from the memory buffer when moving the scan position, calculate integral images of a region newly added to the search window, and add and hold the calculated integral images in the memory buffer.

The scanning unit may continuously hold integral images of a region adjacent to the region newly added to the search window at the subsequent scan position in the memory buffer when moving the scan position, and the integral images of the region newly added to the search window may be recursively calculated using the integral images of the adjacent region held in the memory buffer.

The scanning unit may continuously hold integral images of a pixel line of a pixel width of one pixel or more just before a next scan line in the memory buffer when moving the scan position on a current scan line, and the integral images of the region of the search window may be recursively calculated using the held integral images of the pixel line at each scan position on a next scan line.

The scanning unit may generate integral images of a region of one column corresponding to a width of the search window at every scan line when performing scanning on the image to be detected in a vertical direction.

The scanning unit may generate integral images of a region of one row corresponding to a height of the search window at every scan line when performing scanning on the image to be detected in a horizontal direction.

According to another embodiment of the present invention, there is provided an image processing method including the steps of: scanning a search window on an image to be detected, generating integral images corresponding to a size of the search window at every scan position, and holding the integral images in a predetermined memory buffer; and applying one or more rectangle filters for detecting a desired object to an image of the search window at each scan position, calculating one or more rectangle features using the integral images held in the memory buffer, and discriminating whether or not the object is detected based on the obtained one or more rectangle features.

According to another embodiment of the present invention, there is provided a computer program described in a computer-readable format such that a process of detecting a desired object from an image to be detected is executed on a computer, the computer program allowing the computer to function as: a scanning means configured to scan a search window on the image to be detected, to generate integral images corresponding to a size of the search window at every scan position, and to hold the integral images in a predetermined memory buffer; and a discrimination means configured to apply one or more rectangle filters for detecting the desired object to an image of the search window at each scan position, to calculate one or more rectangle features using the integral images held in the memory buffer, and to discriminate whether or not the object is detected based on the obtained one or more rectangle features.

The computer program of the present invention defines a computer program described in a computer-readable format such that a predetermined process is realized on a computer. In other words, by installing the computer program of the present invention, the cooperative operation is performed on the computer such that the same effect as the image processing device of the present invention may be obtained.

According to the present invention, in the object detection using the rectangle filter, it is possible to provide an excellent image processing device, image processing method and computer program, which is capable of reducing a memory buffer amount for holding integral images used when rectangle features are calculated.

According to the present invention, in the object detection process using the rectangle filter, the rectangle features are rapidly calculated using the integral images. However, since the partial integral images corresponding to the size of the search window are generated at every scan position, capacity of the memory buffer corresponds to the size of the partial integral images. As compared with the case where the integral images correspond to the size of the entire image to be detected is held, it is possible to significantly reduce the capacity of the memory buffer for the integral image.

According to the present invention, since the integral images are calculated with respect to the region newly included in the search window upon scanning and are added to and held in the memory buffer while continuously holding a value in the memory buffer which is still necessary at a subsequent scan position among the integral images corresponding to the already calculated search window, it is possible to reduce the calculation amount of the integral images.

According to the present invention, the integral images of the region added to the memory buffer are recursively calculated using the calculated integral pixel values of the pixel points adjacent to a target pixel point. It is possible to simplify the calculation of the integral image of the target pixel point.

According to the present invention, since the integral images of the region of the search window are recursively calculated using the integral images of the pixel line held when moving the scan position on the preceding scan line, it is possible to simplify the calculation of the integral images. The capacity of the memory buffer corresponds to the size capable of holding the integral images of the search window and the pixel line. Therefore, as compared with the case of holding the integral images corresponding to the size of the entire image to be detected, it is possible to significantly reduce the memory capacity.

According to the present invention, the capacity of the memory buffer corresponds to the size capable of holding the integral images of one column corresponding to the width of the search window. Therefore, as compared with the case of holding the integral images corresponding to the size of the entire image to be detected, it is possible to significantly reduce the memory capacity.

According to the present invention, the capacity of the memory buffer corresponds to the size capable of holding the integral images of one row corresponding to the width of the search window. Therefore, as compared with the case of holding the integral images corresponding to the size of the entire image to be detected, it is possible to significantly reduce the memory capacity.

The other objects, features and advantages of the present invention will become apparent from the detailed description based on the following embodiments of the invention or the accompanying drawings.

### BRIEF DESCRIPTION OF THE DRAWINGS

FIG. 1A is a diagram showing a configuration example (primary differential filter) of a rectangle filter;

FIG. 1B is a diagram showing a configuration example (secondary differential filter) of a rectangle filter;

FIG. 1C is a diagram showing a configuration example (third differential filter) of a rectangle filter;

FIG. 1D is a diagram showing a configuration example (Laplacian filter) of a rectangle filter;

FIG. 2A is a diagram showing an input image before being applied to a rectangle filter;

FIG. 2B is a diagram showing a result of applying a primary differential vertical filter to the input image shown in FIG. 2A;

FIG. 2C is a diagram showing the primary differential vertical filter applied to the input image shown in FIG. 2A;

FIG. 3 is a schematic diagram showing a sequential process of detecting an object from an input image using a plurality of rectangle filters;

FIG. 4 is a diagram illustrating a method of calculating an integral image applied to a rectangle filter for a vertical/horizontal direction;

FIG. 5 is a diagram illustrating a method of calculating an integral pixel value of a target pixel point from integral pixel values of three adjacent pixel points and a luminance value of the target pixel point;

FIG. 6 is a diagram illustrating a method of rapidly calculating a sum of luminance values in a certain rectangle region within an image using an integral image for a vertical/horizontal rectangle filter;

FIG. 7 is a diagram illustrating a method of calculating an integral image applied to a rectangle filter for an oblique direction;

FIG. 8 is a diagram illustrating a method of calculating an integral pixel value of a target pixel point from the integral pixel value of three adjacent pixel points and a luminance value of the target pixel point;

FIG. 9 is a diagram illustrating a method of rapidly calculating a sum of luminance values in a certain rectangle region within an image using an integral image for an oblique rectangle filter;

FIG. 10 is a schematic block diagram showing the functional configuration of an object detection device 10 according to an embodiment of the present invention;

FIG. 11 is a diagram showing a state in which a scaling unit generates a reduced image;

FIG. 12 is a diagram showing a state in which a scanning unit scans a search window S having a predetermined window size on an input image.

FIG. 13 is a diagram showing the configuration of a discrimination unit;

FIG. 14A is a diagram showing a region for newly calculating an integral pixel value at each scan position of an input image and a region for holding an integral pixel value in a memory buffer;

FIG. 14B is a diagram showing a region for newly calculating an integral pixel value at each scan position of an input image and a region for holding an integral pixel value in a memory buffer;

FIG. 14C is a diagram showing a region for newly calculating an integral pixel value at each scan position of an input image and a region for holding an integral pixel value in a memory buffer;

FIG. 14D is a diagram showing a region for newly calculating an integral pixel value at each scan position of an input image and a region for holding an integral pixel value in a memory buffer;

FIG. 14E is a diagram showing a region for newly calculating an integral pixel value at each scan position of an input image and a region for holding an integral pixel value in a memory buffer;

FIG. 14F is a diagram showing a region for newly calculating an integral pixel value at each scan position of an input image and a region for holding an integral pixel value in a memory buffer;

FIG. 14G is a diagram showing a region for newly calculating an integral pixel value at each scan position of an input image and a region for holding an integral pixel value in a memory buffer;

FIG. 15 is a diagram illustrating the capacity of a memory buffer necessary when a vertical direction (Y direction) of an input image is a scan line;

FIG. 16 is a diagram illustrating the capacity of a memory buffer necessary when a horizontal direction (X direction) of an input image is a scan line;

FIG. 17 is a flowchart illustrating a sequential process of calculating a rectangle feature by a rectangle filter for a vertical/horizontal direction using an integral image;

FIG. 18 is a diagram showing a state in which an integral image corresponding to a width of a search window is generated for each scan line and is held in a memory buffer, if a vertical direction of an input image is a scan direction;

FIG. 19 is a diagram showing a state in which an integral image corresponding to a height of a search window is generated for each scan line and is held in a memory buffer, if a vertical direction of an input image is a scan direction;

FIG. 20A is a diagram showing a region for newly calculating an integral pixel value at each scan position of an input image and a region for holding an integral pixel value in a memory buffer;

FIG. 20B is a diagram showing a region for newly calculating an integral pixel value at each scan position of an input image and a region for holding an integral pixel value in a memory buffer;

FIG. 20C is a diagram showing a region for newly calculating an integral pixel value at each scan position of an input image and a region for holding an integral pixel value in a memory buffer;

FIG. 20D is a diagram showing a region for newly calculating an integral pixel value at each scan position of an input image and a region for holding an integral pixel value in a memory buffer;

FIG. 20E is a diagram showing a region for newly calculating an integral pixel value at each scan position of an input image and a region for holding an integral pixel value in a memory buffer;

FIG. 20F is a diagram showing a region for newly calculating an integral pixel value at each scan position of an input image and a region for holding an integral pixel value in a memory buffer;

FIG. 20G is a diagram showing a region for newly calculating an integral pixel value at each scan position of an input image and a region for holding an integral pixel value in a memory buffer; and

FIG. 21 is a flowchart illustrating a sequential process of calculating a rectangle feature by a rectangle filter for an oblique direction using an integral image.

### DESCRIPTION OF THE PREFERRED EMBODIMENTS

Hereinafter, embodiments of the present invention will be described in detail with reference to the accompanying drawings.

A rectangle filter based on the Haar basis is a two-dimensional filter including a combination of black rectangles and white rectangles. A differential degree varies according to the number of black and white rectangles. The rectangle filter is largely divided into a rectangle filter for a vertical/horizontal direction in which white rectangles and black rectangles are aligned in a vertical or horizontal direction and a rectangle filter for an oblique direction (in the present invention, for simplification of description, only an oblique filter inclined by ±45 degrees in an oblique direction is used) in which white rectangles and black rectangles are aligned in an oblique direction.

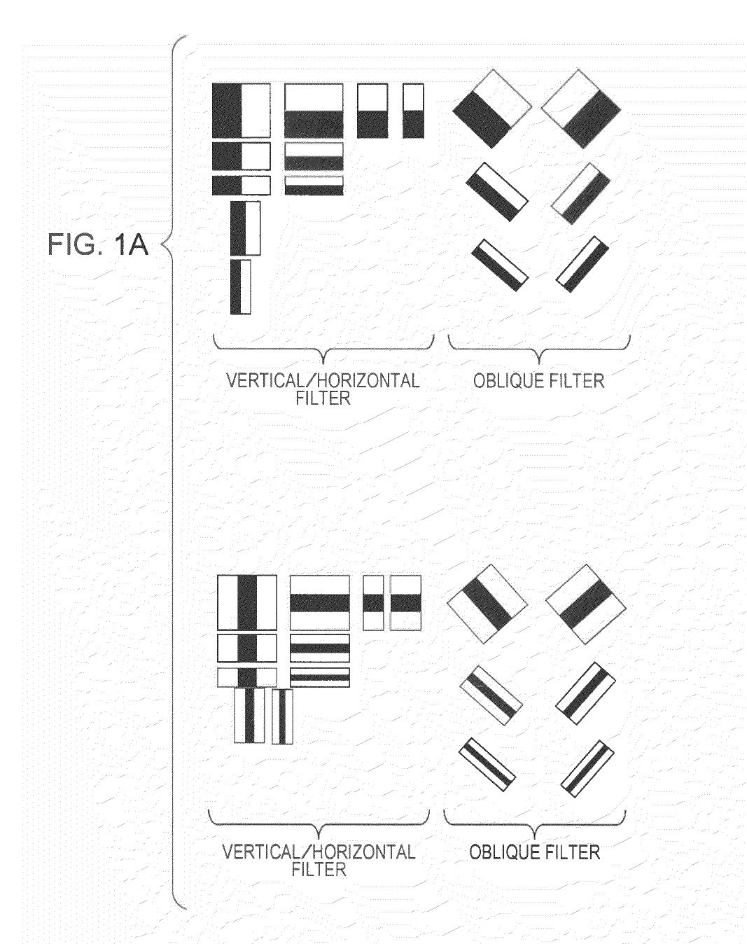

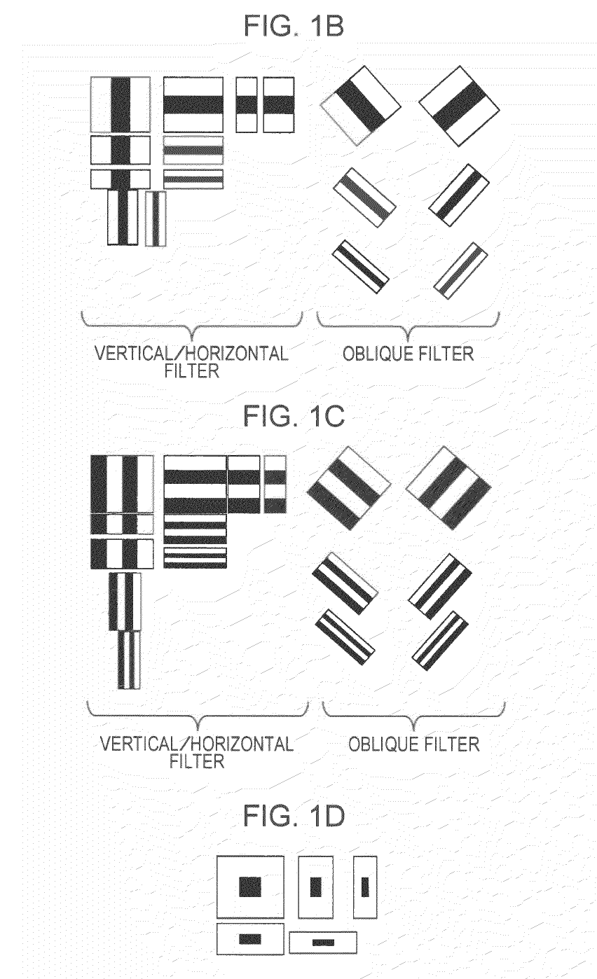

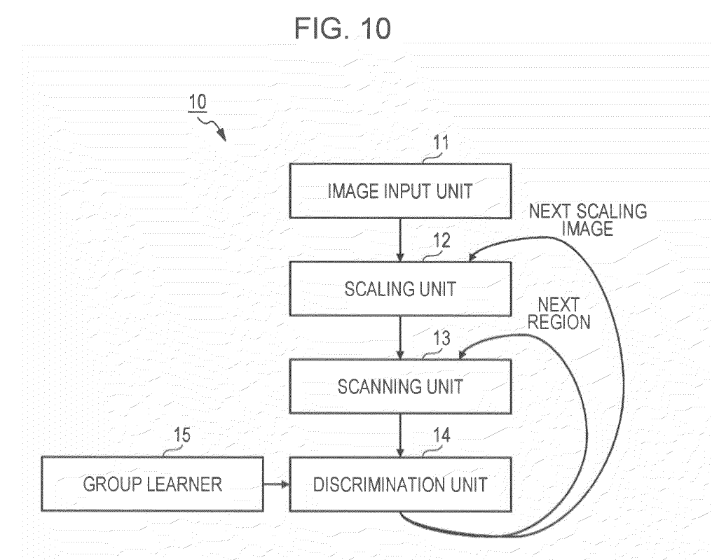

FIGS. 1A to 1C show a rectangle filter. A primary differential filter may extract a feature, which varies from white to black or from black to white, from an input image (see FIG. 1A). A secondary differential filter may extract a feature, which varies in order of white, black and white or in order of black, white and black, from an input image (see FIG. 1B). A third differential filter may extract a feature, which further complexly varies in order of white, black, white and black, from an input image (see FIG. 10). In addition, a Laplacian filter shown in FIG. 1D may be used. A method of extracting a feature of an object by varying the direction and the size of a black and white rectangle by 0 degree, 45 degrees, 90 degrees and 135 degrees is well known in an image recognition field.

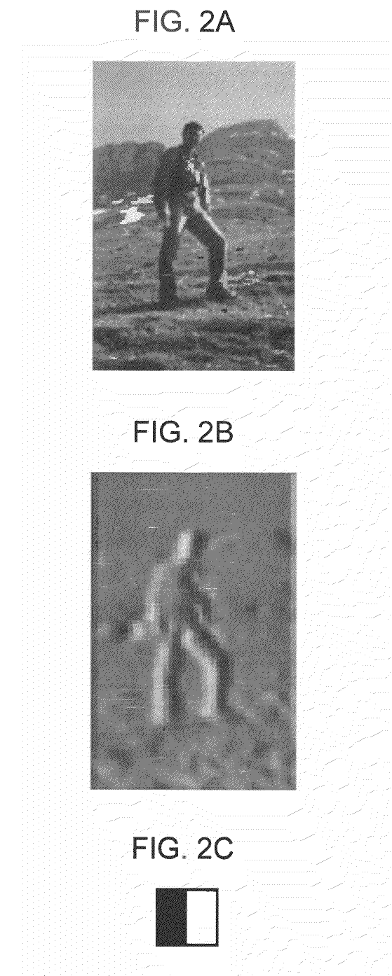

FIG. 2B shows a result of applying a primary differential vertical filter shown in FIG. 2C with respect to an input image shown in FIG. 2A. From the same drawing, it can be seen that an edge of a vertical direction may be extracted from an input image if a vertical filter having a black and white rectangle boundary in a vertical direction is used. Although not shown, if a horizontal filter having a black and white rectangle boundary in a horizontal direction is used, an edge of a horizontal direction may be extracted from an input image.

Each of rectangle filters shown in FIGS. 1A to 1D may be one weak discriminator. A weak discriminator determines whether or not an object is detected by determining whether a rectangle feature obtained by superposing a rectangle filter on a search region, that is, depending on whether a difference between a sum of luminance values within a region corresponding to a black rectangle and a sum of luminance values within a region corresponding to a white rectangle is greater than a threshold. For example, using a learning result in which the luminance value of an eye region is lower than that of a cheek region, it is possible to discriminate a face region from an input image based on a rectangle feature with a certain degree of probability. Although an individual weak discriminator is slightly better than random, it is possible to build a stronger discriminator by linearly coupling a plurality of weak discriminators. Such a discrimination system is generally divided into a learning phase and a recognition phase and statistical learning is performed from a large amount of image samples and rectangle features. As the outline of learning, for example, boosting (Adaboost) may be applied.

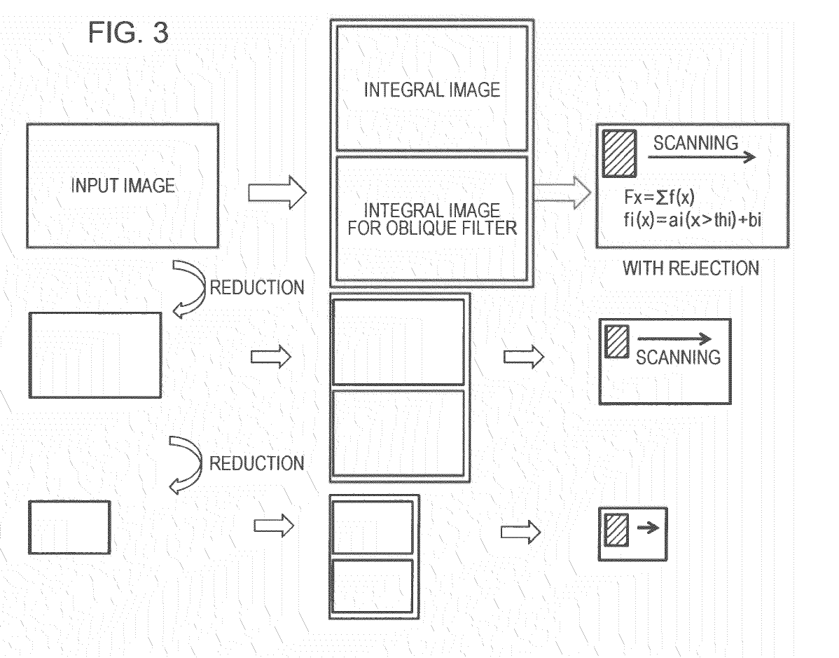

As described above, if an integral image is used, it is possible to rapidly calculate a rectangle feature. FIG. 3 schematically shows a sequential process of detecting an object based on a rectangle feature.

First, an integral mage is prepared from an input image. Since the methods of preparing the integral image are different for the vertical/horizontal rectangle filter and for the oblique direction rectangle filter (described later), two kinds of integral images are prepared for the vertical/horizontal rectangle filter and for the oblique direction rectangle filter.

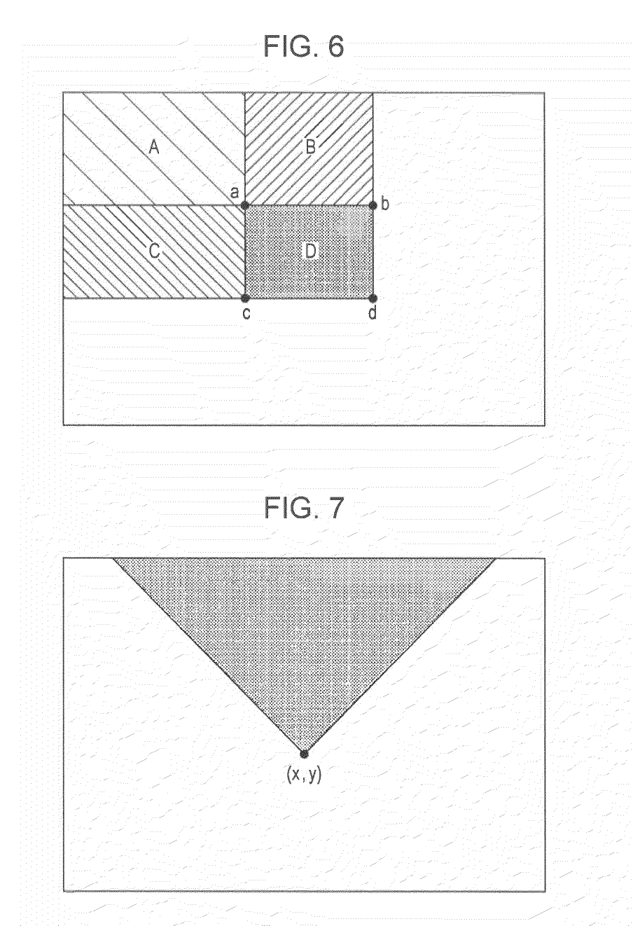

Subsequently, each rectangle filter is scanned on the input image, a rectangle feature of each scan position (x, y) is summed (or weight-summed), and a detection score F(x, y) is calculated. By using the integral image, it is possible to rapidly calculate the rectangle feature at every scan position (see FIG. 6, FIG. 9 and the following description). When the detection score reaches a certain threshold or more, it is determined that a desired object is detected at that scan position (x, y).

The threshold of the detection score F(x, y) is, for example, learned in advance using a statistical learner such as boosting or a support vector machine (SVM). In the case of using boosting, if a rectangle feature obtained from an i-th rectangle filter of the scan position (x, y) is set to fᵢ(x, y), the detection score F(x, y) is described as Equation (1). Although Equation (1) is a general arithmetic average, each rectangle feature fᵢ(x, y) may be weight-added so as to obtain the detection score F (x, y) (described later).

$$\begin{matrix}Equation 1 & \\ F ( x , y ) = {\sum }_{i} {f}_{i} ( x , y ) & ( 1 )\end{matrix}$$

According to a maximum detection score obtained by scanning the input image, a detected result is negative (rejection), that is, a result that the object is not detected may be returned. In addition, while scale transformation is performed, that is, the size of the input image is changed, the generation of the integral image and the calculation of the detection score are repeatedly performed.

In addition, if an initially calculated integral image is subjected to scale transformation, a window having a certain size may be searched for. However, if the integral image is subjected to scale transformation, a calculation amount is increased and the effect in which the process is rapidly performed using the integral image is offset. Accordingly, in the example shown in FIG. 3, when the input image is subjected to scale transformation, the integral image is calculated again.

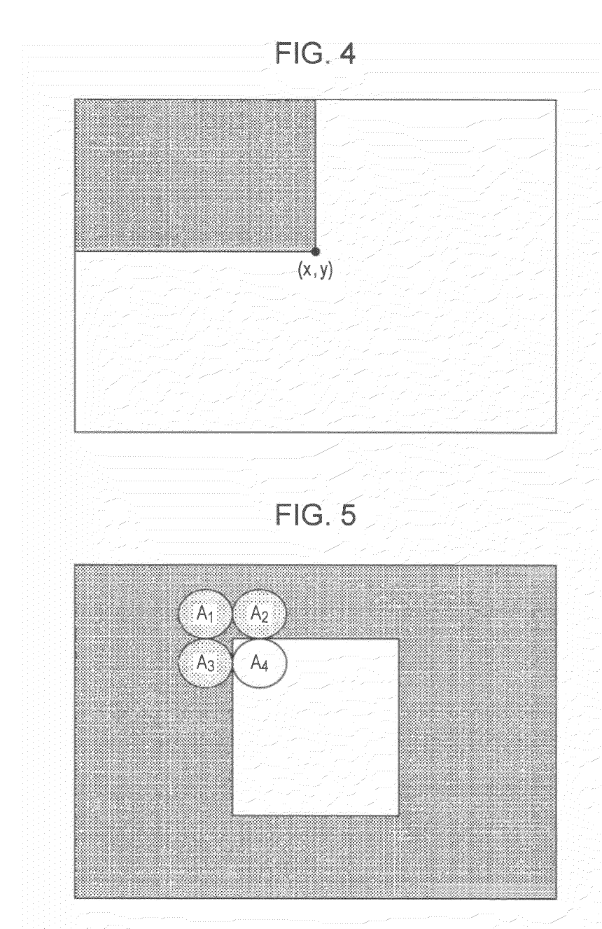

The method of calculating the integral image applied to the vertical/horizontal direction rectangle filter will be described with reference to FIG. 4. An integral image for the vertical or horizontal direction rectangle filter represents each pixel point (x, y) by an integral pixel value obtained by integrating pixel feature amounts (luminance values, in the case of a luminance image) of all pixel points within a rectangle region (in other words, within a rectangle region of the left side of x on the upper side of y) having an original point (0, 0) and the pixel point (x, y) of the input image as apexes on a diagonal line. The integral pixel value ii(x, y) of the pixel point (x, y) is a sum of the luminance values i(x′, y′) of all pixel points (x′, y′) within a rectangle region of the left side of x on the upper side of y and is described by Equation (2) (for example, see Paul Viola & Michael Jones “Robust Real-Time Face Detection” (International Journal of Computer Vision, 2004)).

$$\begin{matrix}Equation 2 & \\ ii ( x , y ) = {\sum }_{{x}^{′} \leq x , {y}^{′} \leq y} i ( {x}^{′} , {y}^{′} ) & ( 2 )\end{matrix}$$

If a variable s(x, y) representing a sum (cumulative row sum) of luminance values per one row is introduced, the integral pixel value ii(x, y) may be recursively calculated as expressed by Equations (3-1) and (3-2) by only scanning the image once (for example, see Paul Viola & Michael Jones “Robust Real-Time Face Detection” (International Journal of Computer Vision, 2004))

Equation 3

S(x,y)=s(x,y−1)+i(x,y) (3-1)

ii(x,y)=ii(x−1,y)s(x,y) (3-2)

where, s(x, −1)=0 and ii(−1, y)=0

According to Equations (3-1) and (3-2), the integral pixel value of a target pixel point may be calculated from integral pixel values of three adjacent pixels and a luminance value of the target pixel point. FIG. 5 shows a method of calculating the integral pixel value ii(A₄) of the target pixel point A₄ from the integral pixel values ii(A₁), ii(A₂) and ii(A₃) of the three adjacent pixel points A₁, A₂ and A₃ and the luminance value i(A₄) of the target pixel point A₄. The calculation equation is expressed as follows.

Equation 4

ii(A₄)=ii(A₂)+ii(A₃)−ii(A₁)+ii(A₄) (4)

If the calculation of the integral pixel values of the three pixel points adjacent to the target pixel point is already completed, by using Equation (4), it is possible to simply obtain the integral image, as compared with the case where the integral pixel values are sequentially calculated according to Equation (2) with respect to all pixel points within the rectangle region of the left side of x on the upper side of y.

FIG. 6 is a diagram illustrating a method of rapidly calculating a sum of luminance values in a certain rectangle region within an image using an integral image for a vertical/horizontal rectangle filter. In the same figure, the sums of the luminance values within the rectangle regions A, A+B, A+C and A+B+C+D are respectively the integral pixel values ii(a), ii(b), ii(c) and ii(d) of the pixel points a, b, c and d. Accordingly, the sum of the luminance values within the rectangle region D may be rapidly calculated by the addition and the subtraction of the integral pixel points ii(a) to ii(d) of the four pixel points a to d, that is, ii(d)−ii(b)−ii(c)+ii(a).

The rectangle filter for the vertical/horizontal direction is configured by aligning white rectangles and black rectangles in the horizontal direction or the vertical direction. The sums of the luminance values within the regions corresponding to the black rectangle and the white rectangle configuring the rectangle filter may be respectively obtained using the integral image as shown in FIG. 6. Accordingly, by subtracting the sum of the luminance values of the region of the black rectangle from the sum of the luminance values of the region of the white rectangle, it is possible to rapidly calculate the rectangle feature of the region on which the rectangle filter of the vertical/horizontal direction is superposed at each scan position.

Subsequently, the method of calculating the integral image for the oblique direction rectangle filter will be described with reference to FIG. 7. The integral image for the oblique direction rectangle filter represents each pixel point (x, y) by an integral pixel value obtained by integrating pixel feature amounts (luminance values, in the case of a luminance image) of all pixel points within an isosceles right triangle region spreading up to the boundary of the input image (in the inverse direction of the scan direction) when a rectangle having the pixel point (x, y) as an apex is rotated around the apex (x, y) by 45 degrees. The integral pixel value RSAT(x, y) of the pixel point (x, y) is a sum of luminance values i(x′, y′) of all pixel points (x′, y′) within the isosceles right triangle region having the pixel point (x, y) as the apex and is described by Equation (5) (for example, see Rainer Lienhart, Alexander Kuranov, Vadim Pisarevsky “Empirical Analysis of Detection Cascades of Boosted Classifier” (DAGM '03, 25th Pattern Recognition Symposium, Magdeburg, Germany, pp. 297-304, September 2003)).

$$\begin{matrix}Equation 5 & \\ RSAT ( x , y ) = {\sum }_{{y}^{′} \leq y , {y}^{′} \leq y - \vert x - {x}^{′} \vert} i ( {x}^{′} , {y}^{′} ) & ( 5 )\end{matrix}$$

Similarly to the integral pixel value ii(x, y) for the vertical/horizontal rectangle filter, by scanning the image once, as expressed by Equation (6), the integral pixel value RSAT(x, y) may be recursively calculated (for example, see Rainer Lienhart, Alexander Kuranov, Vadim Pisarevsky “Empirical Analysis of Detection Cascades of Boosted Classifier” (DAGM '03, 25th Pattern Recognition Symposium, Magdeburg, Germany, pp. 297-304, September 2003)).

Equation 6

RSAT(x,y)=RSAT(x−1,y−1)+RAST(x+1,y−1)−RAST(x,y−2)+i(x,y)+i(x,y−1) (6)

where, RSAT(−1, y)=RSAT(x, −1)=RSAT(x, −2)=RSAT(−1, −1)=RSAT(−1, −2)=0

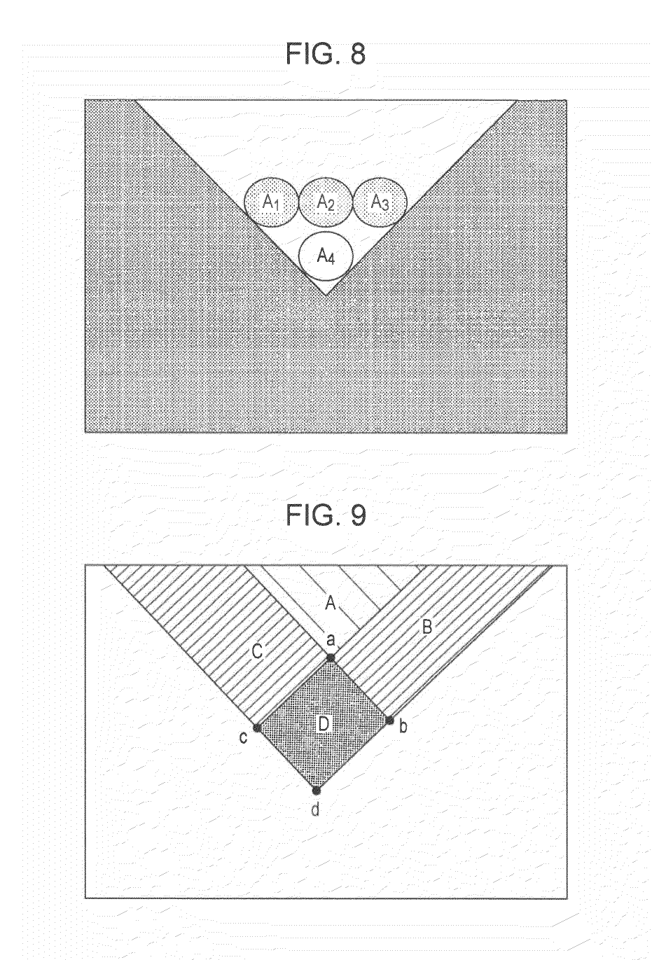

According to Equation (6), the integral pixel value of a target pixel point may be calculated from integral pixel values of three adjacent pixels and a luminance value of the target pixel point. FIG. 8 shows a method of calculating the integral pixel value RSAT(A₄) of the target pixel point A₄ from the integral pixel values RSAT(A₁), RSAT(A₂) and RSAT(A₃) of the three adjacent pixel points A₁, A₂ and A₃ and the luminance value i(A₄) of the target pixel point A₄. The calculation equation is expressed as follows.

Equation 7

RSAT(A₄)=RSAT(A₁)+RSAT(A₃)−RSAT(A₂)+i(A₄) (7)

If the calculation of the integral pixel values of the three pixel points adjacent to the target pixel point is already completed, by using Equation (7), it is possible to simply obtain the integral image (similar to above), as compared with the case where the integral pixel values are sequentially calculated according to Equation (5) with respect to all pixel points within the isosceles right triangle region having the target pixel point as the apex.

FIG. 9 is a diagram illustrating a method of rapidly calculating a sum of luminance values in a certain rectangle region within an image using an integral image for an oblique direction rectangle filter. In the same figure, the sums of the luminance values within the rectangle regions A, A+B, A+C and A+B+C+D are respectively the integral pixel values RSAT(a), RSAT(b), RSAT(c) and RSAT(d) of the pixel points a, b, c and d. Accordingly, the sum of the luminance values within the rectangle region D may be rapidly calculated by the addition and the subtraction of the integral pixel points RSAT(a) to RSAT(d) of the four pixel points a to d, that is, RSAT(d)−RSAT(b)−RSAT(c)+RSAT(a).

The rectangle filter for the oblique direction is configured by aligning white rectangles and black rectangles in the direction of 45 degrees or −45 degrees. The sum of the luminance values within the region corresponding to the black rectangle and the sum of the luminance values within the region corresponding to the white rectangle may be respectively obtained using the integral image as shown in FIG. 9. Accordingly, by subtracting the sum of the luminance values of the region of the black rectangle from the sum of the luminance values of the region of the white rectangle, it is possible to rapidly calculate the rectangle feature of the region on which the rectangle filter of the oblique direction is superposed at each scan position.

In the related art, if the calculation of the rectangle feature is performed using the integral image disclosed in Paul Viola & Michael Jones “Robust Real-Time Face Detection” (International Journal of Computer Vision, 2004) and Rainer Lienhart, Alexander Kuranov, Vadim Pisarevsky “Empirical Analysis of Detection Cascades of Boosted Classifier” (DAGM '03, 25th Pattern Recognition Symposium, Magdeburg, Germany, pp. 297-304, September 2003), in general, the integral image having the same size as the input image is generated from the input image once according to the calculation equation described in Equation (2) or (5) (see FIG. 3) and the rectangle filter is scanned on the integral image so as to calculate a score. However, the generation of the integral image having the same size as the input image means that the memory buffer has the same size as the input image is necessary and, for example, if the input image is a VGA image, a 1.2-megabyte memory buffer is necessary for an integral image. Such a memory capacity is problematic upon hardware mounting or upon processing on a PC or a built-in device having a small memory capacity.

In an object detection process, while a search window is scanned on an input image, a rectangle feature of each rectangle filter is sequentially calculated at every scan position. If the rectangle feature is calculated at each scan position, the integral image of a region corresponding to the size of an object to be detected, that is, the size of the search window, is necessary.

Accordingly, the present inventors propose a method of generating a partial integral image having a necessary size corresponding to the size of the search window at every scan position without generating the integral image of the entire input image so as to calculate a rectangle feature. According to such a proposed method, it is possible to rapidly calculate the rectangle feature using the integral image and to reduce the capacity of the memory buffer holding the integral image.

For example, if the size of the search window is 64×32 pixels, the memory capacity necessary for holding the integral image corresponding to the size of the search window is about 11 kilobytes (if one pixel is represented by 4 bytes). It is possible to remarkably reduce a memory amount to about 1/100 when compared with the case where the integral image of the entire input image is held.

FIG. 10 schematically shows the functional configuration of an object detection device 10 according to an embodiment of the present invention. The shown object detection device 10 includes an image input unit 11, a scaling unit 12, a scanning unit 13, a discrimination unit 14, and a group learner 15.

The image input unit 11 receives, for example, a gradation image (luminance image) photographed by a digital camera. The scaling unit 12 outputs a scaled image by scaling up or down the input image to all designated scales. The scanning unit 13 sequentially and horizontally scans a search window having a size of an object to be detected from, for example, an uppermost line downward with respect to each scaled image and crops a window image at a current scan position. The discrimination unit 14 discriminates whether or not a desired object (for example, a special part such as a subject's face or hand) is present in each window image sequentially scanned by the scanning unit 13 and outputs a position and a size indicating the region of the detection window S as the detection result when an object is detected. The discrimination unit 14 includes a plurality of weak discriminators. A rectangular filter is used in each weak discriminator and a rectangle feature is rapidly calculated using an integral image. The scanning unit 13 sequentially generates an integral image having a size corresponding to the window image at every scan position so as to save a memory capacity for holding the integral image.

The group learner 15 executes group learning of the plurality of weak discriminators configuring the discrimination unit 14 by group learning. The discrimination unit 14 discriminates whether or not a desired object is present within a window image at every scan position, by referring to the learning result of the group learner 15. In addition, the group learner 15 may be a component within the object detection device 10 or an external independent device.

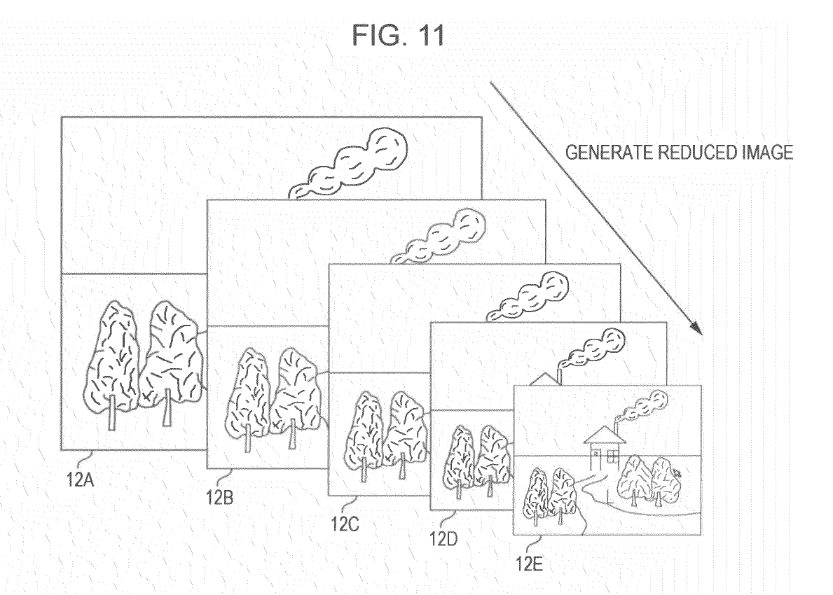

The image (luminance image) input to the image input unit 11 is first supplied to the scaling unit 12. In the scaling unit 12, for example, the image is reduced using bilinear interpolation. A plurality of reduced image is not initially generated, but a process of outputting a necessary image to the scanning unit 13, processing the image, and generating a next smaller reduced image is repeated. FIG. 11 shows a state in which the scaling unit 12 sequentially generates reduced images 12A, 12B, 12C, . . . . As shown in the same drawing, the input image 12A is output to the scanning unit 13 without change, the completion of the process of the scanning unit 13 and the discrimination unit 14 is awaited, and an input image 12B obtained by reducing the size of the input image 12A is generated. Subsequently, as an input image 12C obtained by reducing the size of the input image 12B is output to the scanning unit 13 after the process of the scanning unit 13 and the discrimination unit 14 of the input image 12B is completed, reduced images 12D, 12E and the like are sequentially generated. The process is completed when the image size of the reduced image is less than the window size scanned by the scanning unit 13. The image input unit 11 outputs a next input image to the scaling unit 12 after such a process is completed.

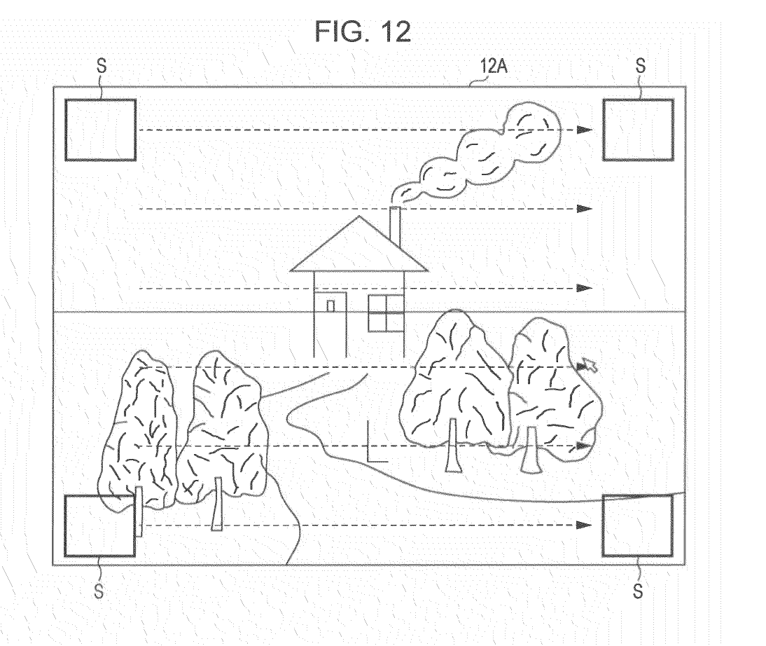

FIG. 12 shows a state in which the scanning unit 13 scans a search window S having a predetermined window size on an input image. The window size is a size accepted (that is, suitable for discrimination of the object) by the discriminator 5 of the next stage and is, for example, 64×32 pixels. The scanning unit 13 applies the search window S to the current scan position on the input image from the scaling unit 12 and crops the window image. In the present embodiment, the scanning unit 13 sequentially generates the integral image having a size corresponding to the search window image at every scan position and saves a memory capacity for holding the integral image. The scanning unit 13 holds the window image and the integral image of the window image at each scan position in a memory buffer (not shown). The window size of the search window S is constant but the input image is sequentially reduced by the scaling unit 12 as shown in FIG. 11 such that scale transition to various image sizes is performed, it is possible to detect an object having a certain size.

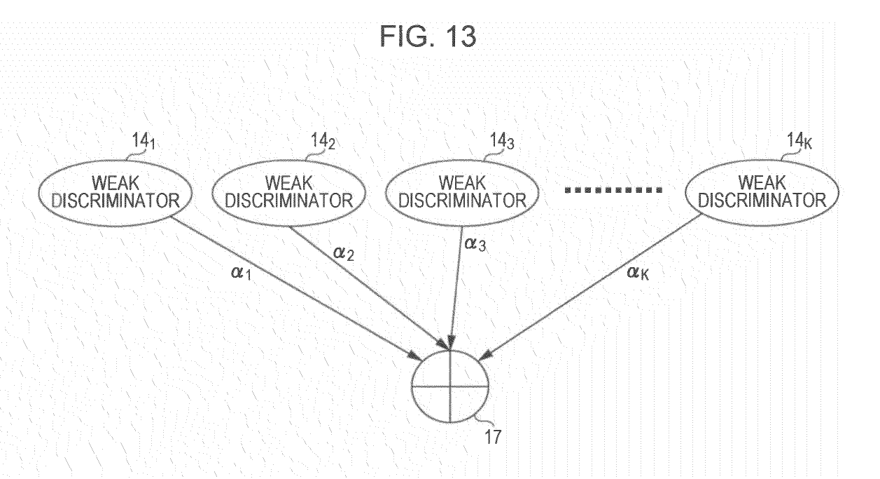

The discrimination unit 14 discriminates whether or not a desired object is included in the window image supplied from the scanning unit 13. FIG. 13 shows the configuration of the discrimination unit 14. The discrimination unit 14 includes a plurality (K) of weak discriminators 14₁ to 14_{K} and an adder 17 for obtaining a weighted majority by respectively multiplying such outputs by weights α₁ to αₖ.

In the present embodiment, a rectangle filter is used in each of the weak discriminators 14₁ to 14_{K} and a rectangle feature is rapidly calculated using an integral image. Each of the weak discriminators 14₁ to 14_{K} rapidly calculates a rectangle feature fᵢ(x, y) at a scan position (x, y) (i is an integer of 1 to K), when an image of a search window and an integral image thereof at a current scan position are read from each memory buffer (as described above). Each rectangle feature fᵢ(x, y) is an estimated value representing whether a desired object is included in a search window by a certain probability. The adder 17 adds the rectangle feature fᵢ(x, y) with weights so as to obtain a detection score F(x, y). The weights α₁ to αₖ attached to each rectangle feature fᵢ(x, y) are coefficients representing the reliability of the weak discriminators 14₁ to 14_{K}. The discrimination unit 14 outputs the added result as a strong discrimination result.

The group learner 15 learns the rectangle filters assigned to the weak discriminators 14₁ to 14_{K} in advance and the weights α₁ to αₖ multiplied to such outputs (rectangle features) by group learning. As the group learning, a method of obtaining the result of the plurality of weak discriminators 14₁ to 14_{K} by majority may be applied. For example, group learning using boosting such as Adaboost for performing the weighting of data so as to perform weighting majority may be applied.

Upon learning, a plurality of learning samples including gradation images discriminated, that is, labeled into two classes of a desired object is input to the weak discriminators 14₁ to 14_{K} so as to learn respective rectangle features in advance. Upon discrimination, the rectangle feature calculated with respect to the window image sequentially supplied from the scanning unit 13 are compared with the rectangle feature amount learned in advance so as to determinably or stochastically output an estimation value for estimating whether or not a desired object is included in the window image.

In AdaBoost, the weak discriminators 14₁ to 14_{K} sequentially calculate estimation values and sequentially update weighted majority values. The rectangle filters respectively used in the weak discriminators 14₁ to 14_{K} are sequentially generated by group learning by the group learner 15 using the learning samples, and, for example, the rectangle features are calculated in the generation order. In addition, the weights α₁ to αₖ (reliability) of the weighted majority are learned in the learning process of generating the weak discriminators 14₁ to 14_{K}.

For details of the group learning of the plurality of weak discriminators, for example, refer to Japanese Unexamined Patent Application Publication No. 2009-140369 (paragraphs 0072 to 0141).

According to the method of generating only the integral image of the search window size at every scan position and calculating the rectangle feature, it is possible to rapidly calculate the rectangle feature using the integral image and to reduce memory capacity. Even in only the necessary size corresponding to the search window, if the integral image is calculated again with respect to all pixel points within the necessary size at every scan position, the calculation time is consumed in each case. Accordingly, the original merit that the rectangle feature is rapidly calculated using the integral image is not obtained.

To this end, when the above proposed method is realized, since an integral image is calculated with respect to only a region which is newly included in the search window upon scanning while the value which is still necessary at the subsequent scan position in the integral image corresponding to the already calculated search window is continuously held in the memory buffer, it is possible to reduce the calculation amount of the integral image. When the integral image of the region added to the memory buffer is calculated, the three pixel points adjacent to the target pixel point are recursively calculated using the calculated integral pixel value (see FIGS. 5 and 8 and Equations (4) and (7)), thereby simplifying the calculation of the integral image of the target pixel point.

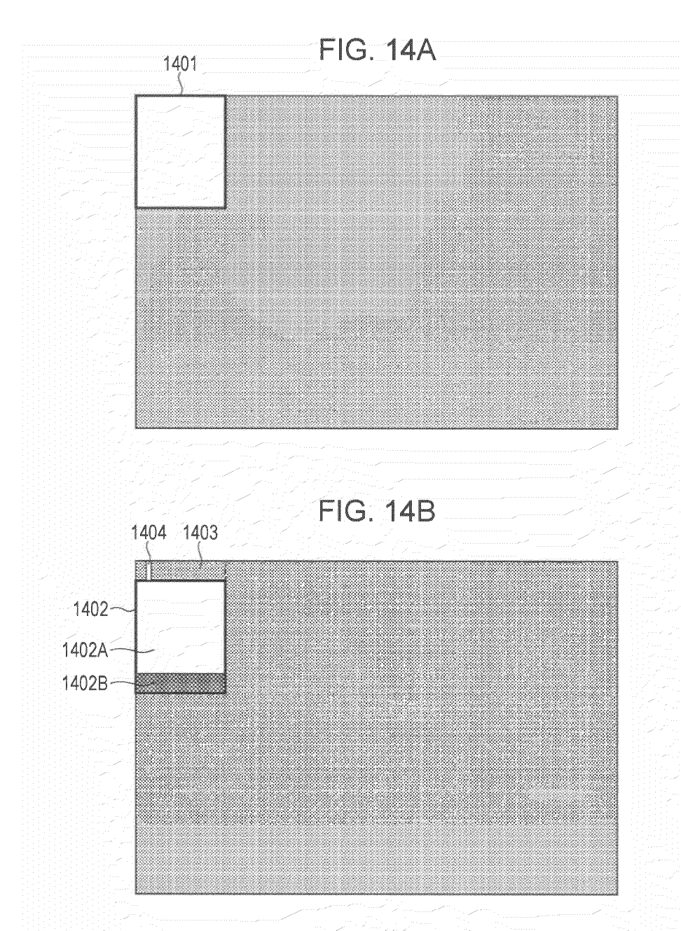

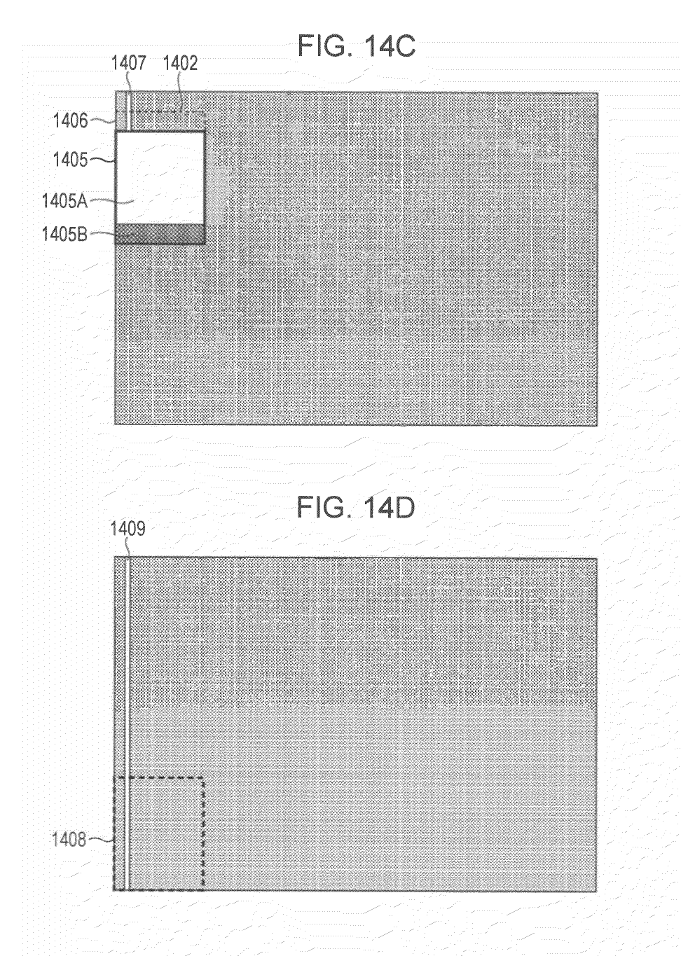

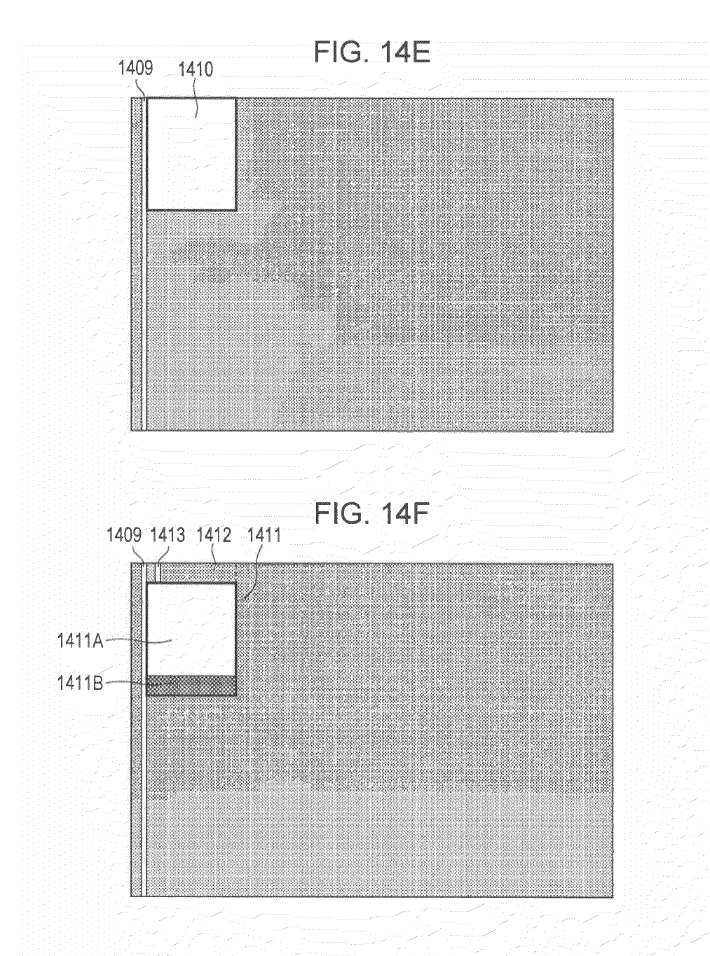

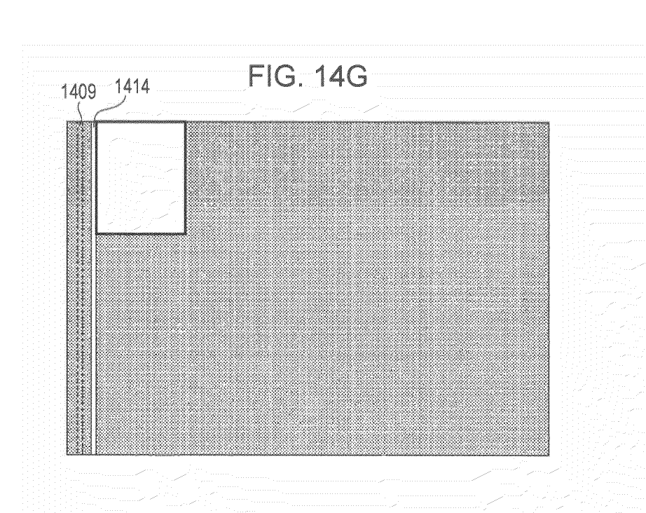

The region, in which the integral pixel position at each scan position of the input image is newly calculated, and the region, in which the integral pixel value is held in the memory buffer, in the case of using the rectangle filter for the vertical/horizontal direction will be described with reference to FIGS. 14A to 14G. The same drawings show an example in which a scan direction is a vertical direction (Y direction). First, the search window is scanned by a predetermined skip width (skip pixels) along the scan line of the vertical direction using an original point (0, 0) as a start position and the generation of the integral image and the calculation of the detection score at every scan position are performed. When the search window reaches the end (the upper limit of the Y coordinate) of the scan direction of the scan direction, the scan line of the search window is skipped by the predetermined skip width (skip pixels) in the horizontal direction and then scanning is repeated.

First, the scanning unit 13 sets the search window to the original point (0, 0), calculates the integral pixel values by Equations (2), (3-1) and (3-2) with respect to all pixel points within the search window region denoted by a reference number 1401 of FIG. 14A, and holds the result in the memory buffer.

When the integral pixel values are calculated, a method of recursively calculating the integral pixel value of the target pixel point by appropriately using the already calculated integral pixel values of the three adjacent pixel points as shown in FIG. 5 and Equation (4) is applied.

In the discrimination unit 14, each of the weak discriminators 14₁ to 14_{K} calculates the rectangle feature fᵢ(0, 0) at the scan position using the integral images within the current search window region 1401 held in the memory buffer and the adder 17 weight-adds the rectangle features and outputs the detection score F(0, 0) at the scan position.

Subsequently, as shown in FIG. 14B, the scanning unit 13 moves the search window along the scan line (x=0) in the vertical direction by the predetermined skip width (skip pixels) (that is, y=y+skip). With respect to each pixel point within the region overlapping with the search window 1401 of the preceding scan position, which is denoted by a reference numeral 1402A, in the search window 1402 of the scan position (0, skip) after movement, the calculated integral pixel values are held in the memory buffer. Accordingly, the scanning unit 13 calculates the integral image with respect to only each pixel within the front end region of the scan direction newly included in the search window 1402 by the movement of the scan position, which is denoted by a reference numeral 1402B, and copies, adds and holds the result in the memory buffer.

When calculating the integral image of the added part denoted by the reference number 1402B of FIG. 14B, the method of recursively calculating the integral pixel value of the target pixel point as shown in FIG. 5 and Equation (4) by appropriately using the already calculated integral pixel values of the three adjacent pixel points within the region 1402 is applied, thereby reducing calculation cost.

Along with the movement of the search window, since the integral images of the region denoted by the reference numeral 1403 of FIG. 14B are not necessary for the subsequent calculation of the rectangle feature, the scanning unit 13 discards the integral images of the region 1403 from the memory buffer. However, the region corresponding to one pixel (that is, one pixel line of x=skip−1) (or the pixel line of the pixel width of one pixel or more) just before the next scan line, which is denoted by the reference numeral 1404, is held in the memory buffer. This is because, if the region 1404 corresponding to one pixel line is used as the already calculated integral pixel values (see FIG. 5) of the pixel point adjacent to the target pixel point when moving to the next scan line (x=skip), the integral pixel value of the target pixels are recursively calculated by Equation (4).

In the discrimination unit 14, each of the weak discriminators 14₁ to 14_{K} calculates the rectangle feature fᵢ(0, skip) at the scan position using the integral image within the current search window region 1402 held in the memory buffer and the adder 17 weight-adds the rectangle features and outputs the detection score F(0, skip) at the scan position.

Subsequently, as shown in FIG. 14C, the scanning unit 13 moves the search window along the scan line (x=0) in the vertical direction by the predetermined skip width (skip pixels) (that is, y=y+skip). The integral pixel values within the region denoted by the reference numeral 1405A in the search window 1405 after movement are held in the memory buffer. Accordingly, the scanning unit 13 calculates the integral pixel values with respect to only each pixel within the region newly included in the search window 1405 by the movement of the scan position, which is denoted by the reference numeral 1405B, and adds and holds the result in the memory buffer. When calculating the integral image of the added region denoted by the reference number 1405B, the integral pixel value of the target pixel point is recursively calculated as shown in FIG. 5 and Equation (4) by appropriately using the already calculated integral pixel values of the three adjacent pixel points within the region 1405.

Along with the movement of the search window, since the integral images of the region denoted by the reference numeral 1406 are not necessary for the subsequent calculation of the rectangle feature, the scanning unit 13 discards the integral images of the region 1406 from the memory buffer. However, the integral image of the region corresponding to one pixel (that is, one pixel line of x=skip−1) (or the pixel line of the pixel width of one pixel or more) just before the next scan line, which is denoted by the reference numeral 1407, is held in the memory buffer by the scanning unit 13, in order to be used as the known integral pixel values of the adjacent pixel points when the integral pixel values are recursively calculated at the next scan line (x=skip).

In the discrimination unit 14, each of the weak discriminators 14₁ to 14_{K} calculates the rectangle feature fᵢ(0, 2skip) at the scan position using the integral image within the current search window region 1405 held in the memory buffer and the adder 17 weight-adds the rectangle features and outputs the detection score F(0, 2skip) at the scan position.

Thereafter, until the search window reaches the end (y=height) of the current scan line (x=0), the processes shown in FIGS. 14B and 14C are repeatedly executed when the search window moves the scan position.

FIG. 14D shows the region in which the integral images are held in the memory buffer when the search window reaches the end (y=height) of the scan line (x=0). Since the integral image within the search window region denoted by the reference numeral 1408 is calculated, but is not necessary for the calculation of the rectangle feature of the next scan line after being used in the calculation of the rectangle feature at the scan position, the scanning unit 13 discards the integral images of the region 1408 from the memory buffer. However, in order to use the integral images of the region corresponding to one pixel (that is, one pixel line of x=skip−1) (or the pixel line of the pixel width of one pixel or more) just before the next scan line, which is denoted by the reference numeral 1409 as the known integral pixel values of the adjacent pixel points when the integral pixel values are recursively calculated at the next scan line, the scanning unit 13 holds the integral images of the region 1409 in the memory buffer.

When the search window reaches the end (y=height) of the scan line (x=0), the scanning unit 13 moves the scan line in the horizontal direction perpendicular to the scan line by the predetermined skip width (skip) (that is, x=skip), sets the search window to the beginning of the scan line (that is, y=0), and begins scanning. While scanning is performed on the scan line (x=skip) so as to calculate the detection score, the scanning unit 13 continuously holds the integral pixel values of the region 1409 held in the process on the preceding scan line (x=0) in the memory buffer. In order to newly calculate the integral pixel value at each scan position on the current scan line (x=skip), the integral pixel value of the target pixel point is recursively calculated by appropriately using the integral pixel value within the region 1409 as the already calculated integral pixel values of the adjacent pixel points.

FIG. 14E shows a state in which the search window is set to the beginning position (y=0) on the next scan line (x=skip). The integral images are calculated with respect to the pixel points within the search window region denoted by the reference numeral 1410. At this time, the integral pixel value of the target pixel point is recursively calculated by appropriately using the already calculated integral pixel values of the three adjacent pixel points within the region 1409 held in the memory buffer as shown in FIG. 5 and Equation (4).

In the discrimination unit 14, each of the weak discriminators 14₁ to 14_{K} calculates the rectangle feature fᵢ(skip, 0) at the scan position using the integral image within the current search window region 1410 held in the memory buffer and the adder 17 weight-adds the rectangle features and outputs the detection score F(skip, 0) at the scan position.

Subsequently, as shown in FIG. 14F, the scanning unit 13 moves the search window along the scan line in the vertical direction by the predetermined skip width (skip pixels) (that is, y=y+skip). With respect to each pixel within the search window region of the preceding scan position, which is denoted by a reference numeral 1411A, in the search window 1411 after movement, the calculated integral pixel values are held in the memory buffer. Accordingly, the scanning unit 13 calculates the integral image value with respect to only each pixel within a region of the front end of the scan direction newly included in the search window 1411 by the movement of the scan position, which is denoted by a reference numeral 1411B, and adds and holds the result in the memory buffer. In order to calculate the integral image of the added part, the integral pixel value of the target pixel point is recursively calculated as shown in FIG. 5 and Equation (4) by appropriately using the already calculated integral pixel values of the three adjacent pixel points within the regions denoted by the reference numerals 1409 and 1411.

By the movement of the search window, since the integral images of the region denoted by the reference numeral 1412 is not necessary for the subsequent calculation of the rectangle feature, the scanning unit 13 discards the integral images of the region 1412 from the memory buffer. However, the scanning unit 13 holds the region corresponding to one pixel (that is, one pixel line of x=2skip−1) (or the pixel line of the pixel width of one pixel or more) just before the next scan line, which is denoted by the reference numeral 1413, in the memory buffer, in order to be used as the known integral pixel values of the adjacent pixel points when the integral pixel values are recursively calculated at the next scan line (x=2skip).

In the discrimination unit 14, each of the weak discriminators 14₁ to 14_{K} calculates the rectangle feature fᵢ(skip, skip) at the scan position using the integral image within the current search window region 1411 held in the memory buffer and the adder 17 weight-adds the rectangle features and outputs the detection score F(skip, skip) at the scan position.

Thereafter, until the search window reaches the end of the current scan line (x=skip), the process shown in FIG. 14F is repeatedly executed when the search window moves the scan position.

When the search window reaches the end (y=height) of the scan line (x=skip), the scanning unit 13 moves the scan line in the horizontal direction perpendicular to the scan line by the predetermined skip width (skip) (that is, x=x+skip=2skip), sets the search window to the beginning of the scan line (that is, y=0), and begins scanning. While scanning is performed on the scan line (x=2skip), the scanning unit 13 continuously holds the integral image of the region 1414 held in the process on the preceding scan line (x=skip) in the memory buffer. In order to newly calculate the integral pixel value at each scan position on the current scan line (x=2skip), the integral pixel value of the target pixel point is recursively calculated by appropriately using the integral pixel values within the region 1414 as the already calculated integral pixel values of the adjacent pixel points. Since the (above-described) integral image within the region 1409 held upon scanning on the scan line just before the preceding scan line is not necessary by the movement of the scan line, the scanning unit 13 discards the integral image within the region 1409 from the memory buffer.

FIG. 14G shows a state in which the search window is set to the beginning position (y=0) on the next scan line (x=2skip). On the scan line, the same processes as those shown in FIGS. 14E and 14F are repeatedly executed. When the scan position reaches the end (y=height) of the scan line (x=2skip), the scan line is moved in the horizontal direction perpendicular to the scan line by the predetermined skip width (skip) (x=x+skip). Then, until the scan line reaches the end (x=width) of the input image, the same processes as those shown in FIGS. 14E to 14G are repeatedly executed.

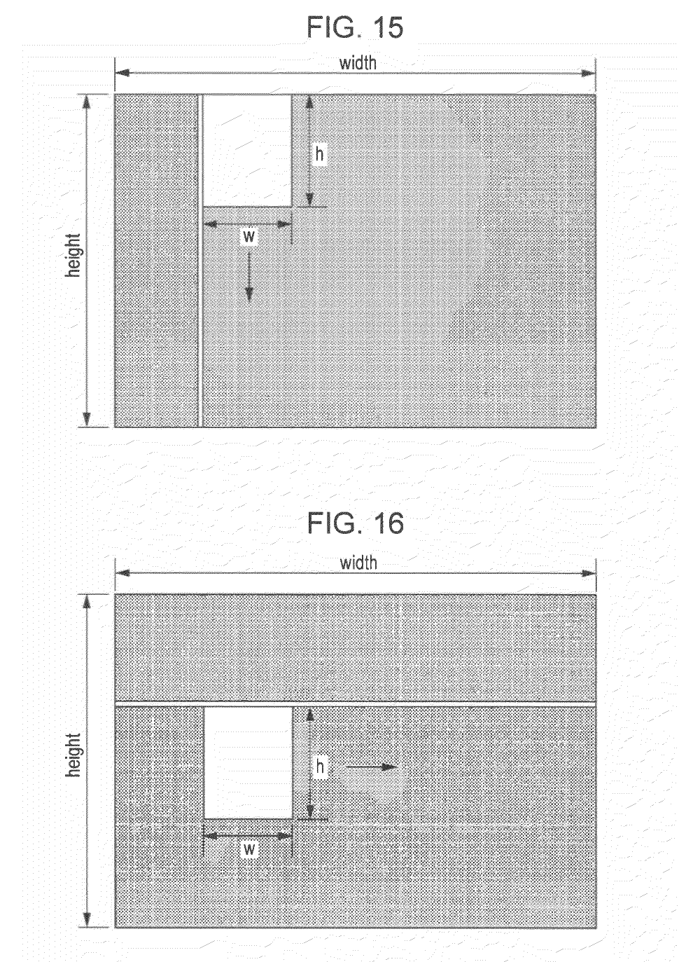

The capacity of the memory buffer necessary when only the integral images of the region corresponding to the size of the search window as shown in FIGS. 14A to 14G and the region necessary for the recursive calculation of the integral pixel values are held in the memory buffer instead of the entire input image will be considered. The width and the height of the input image are respectively set to width and height, the size of the search window is w×h, and one pixel is expressed by n bytes. As shown in FIGS. 14A to 14G, if the vertical direction (Y direction) of the input image is the scan line, as shown in FIG. 15, (height+w×h)×n-byte memory capacity is necessary for holding the integral image. For example, if the input image is a VGA screen, the size of the search window is expressed by 32×64 pixels and one pixel is expressed by 4 bytes, the memory capacity is (480+32×64)×4=10,336 bytes, that is, about 11 kilobytes. As shown in FIG. 3, since a buffer of about 1.2 megabyte is necessary for holding the integral images with respect to the entire VGA image, the memory capacity saving effect is significant. If the scan direction is the vertical direction, the memory region is continuous and is prone to be treated.

If the vertical direction (X direction) of the input image is the scan line, as shown in FIG. 16, memory capacity of (width+w×h)×n bytes is necessary for holding the integral image. For example, if the input image is a VGA screen, the size of the search window is expressed by 32×64 pixels and one pixel is expressed by 4 bytes, the memory capacity is (640+32×64)×4=10,752 bytes, that is, about 11 kilobytes. Thus, the memory saving effect is large (similar to the above case).

Although the skip width (skip) when the search window is scanned is one pixel and the capacity of the memory buffer necessary for holding the integral image is estimated in FIGS. 15 and 16, the scope of the present invention is not limited to a specific skip width.

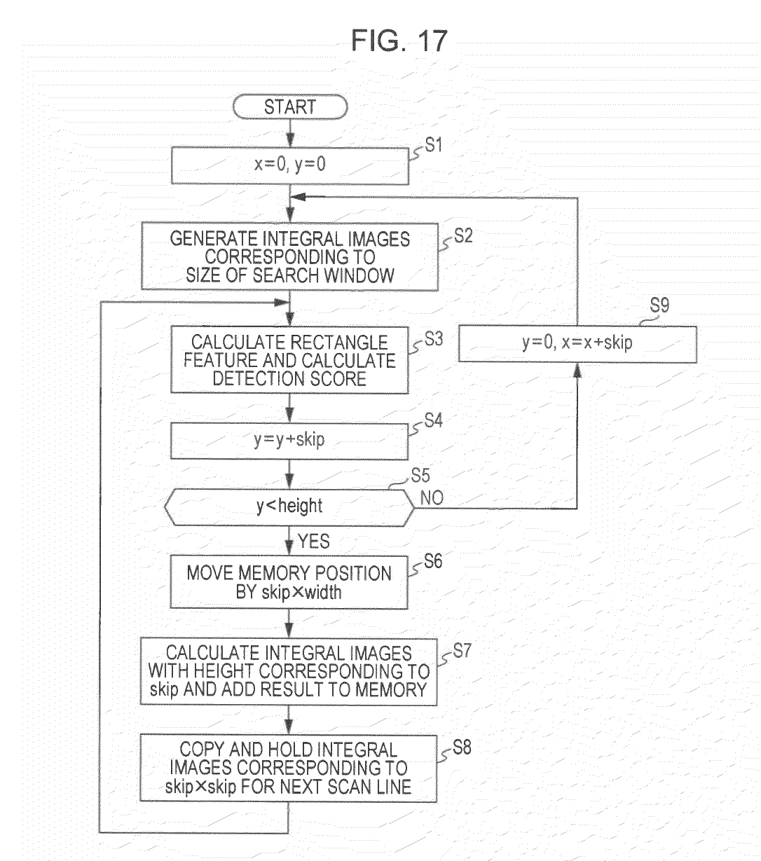

FIG. 17 shows a flowchart of a process of calculating a rectangle feature by a rectangle filter for a vertical/horizontal direction using an integral image. As shown in FIG. 14, a scan direction is a vertical direction (Y direction) and a movement amount of a scan position per one scan of each XY direction is skip (the number of pixels).

First, as shown in FIG. 14A, the scanning unit 13 sets a scan position (x, y) to an original point (0, 0) and begins to scan a search window on a scan line of x=0 (step S1).

The scanning unit 13 generates integral images corresponding to the size of the search window set at the current scan position (x, y) (step S2) and holds the integral image in the memory buffer for the integral image. With respect to the region in which the calculated integral pixel values in the search window are held in the memory buffer, these integral images are used. When the integral images are generated, the integral pixel values are recursively calculated by appropriately using the integral pixel values of the already calculated adjacent pixel points.

The scanning unit 13 applies the search window to the current scan position (x, y) on the input image and crops the window image from the memory buffer for the input image. In the discrimination unit 14, when the integral images are read from the memory buffer for the integral image, each of the weak discriminators 14₁ to 14₄ rapidly calculates the rectangle feature fᵢ(x, y) of the rectangle filter (the filter for the vertical/horizontal direction) (see FIG. 6). Then, the adder 17 weight-adds each rectangle feature fᵢ(x, y) and calculates a detection score at the current scan position (x, y) (step S3).

If the calculation of the rectangle feature at the current scan position (x, y) and the calculation of the detection score are completed in the discrimination unit 14, the scanning unit 13 moves the scan position. That is, the scanning unit 13 adds a predetermined skip width (skip) to the y coordinate of the current scan position (step S4) and moves the scan position along the scan line, that is, the Y direction.

At this time, the scanning unit 13 checks whether the y coordinate of the scan position is less than the height of the input image, that is, whether the scan position does not reach the end of the current scan line (step S5).

If the scan position does not reach the end of the current scan line (Yes of step S5), the scanning unit 13 updates the region in which the integral pixel values are held in the memory buffer for the integral image and performs the calculation of the integral pixel values. In detail, the region of the search window to hold the integral images is moved by skip×width (step S6).

At this time, the scanning unit 13 calculates the integral pixel value with respect to only each pixel point within the region (for example, the region denoted by the reference numeral 1403 of FIG. 14B) in which the integral pixel values are not still calculated and which is newly included in the search window, and adds and holds the result in the memory buffer (step S7). At this time, the integral pixel values are recursively calculated by appropriately using the integral pixel values of the already calculated adjacent pixel points.

Since the region (for example, the region denoted by the reference numeral 1405 of FIG. 14B) corresponding to one pixel (that is, one pixel line of x=skip−1) (or the pixel line of the pixel width of 1 pixel or more) just before the next scan line is used in the recursive calculation of the integral pixel values at the next scan line, the scanning unit 13 holds the integral pixel value of each pixel point within the region in the memory buffer (step S8). The integral pixel values of the region (for example, the region denoted by the reference numeral 1404 of FIG. 14B) deviated from the search window by the movement of the search window are discarded from the memory buffer.

When the scan width (skip) exceeds the width w of the search window, in step S8, instead of the above process, a process of calculating the integral pixel values corresponding to skip×skip pixels and copying the integral pixel values in the memory buffer is performed.

When the scan position (x, y) reaches the end of the current scan line (No of step S5), the scanning unit 13 moves the search window to the next scan line. That is, the scanning unit 13 returns the y coordinate position of the search window to 0, adds the predetermined skip width (skip) to the x coordinate position (step S9). Then, returning to step S2, the above-described process is repeatedly executed on the next scan line.

Although FIGS. 14A to 14G and 17 show the method of sequentially generating the integral image with respect to the region newly added when the scan position is moved on the scan line, the scope of the present invention is not limited to a specific skip width. The necessary integral images in the scan units may be generated in a batch in scan line units and may be held in the memory buffer until the scan line is moved. Even in the latter case, the memory capacity saving effect is obtained, as compared with the case where the integral images are held over the entire input image. On the same scan line, only one process of generating the integral image may be performed only once and, when the scan position is moved, the address for reading the integral image from the memory buffer may be only changed.

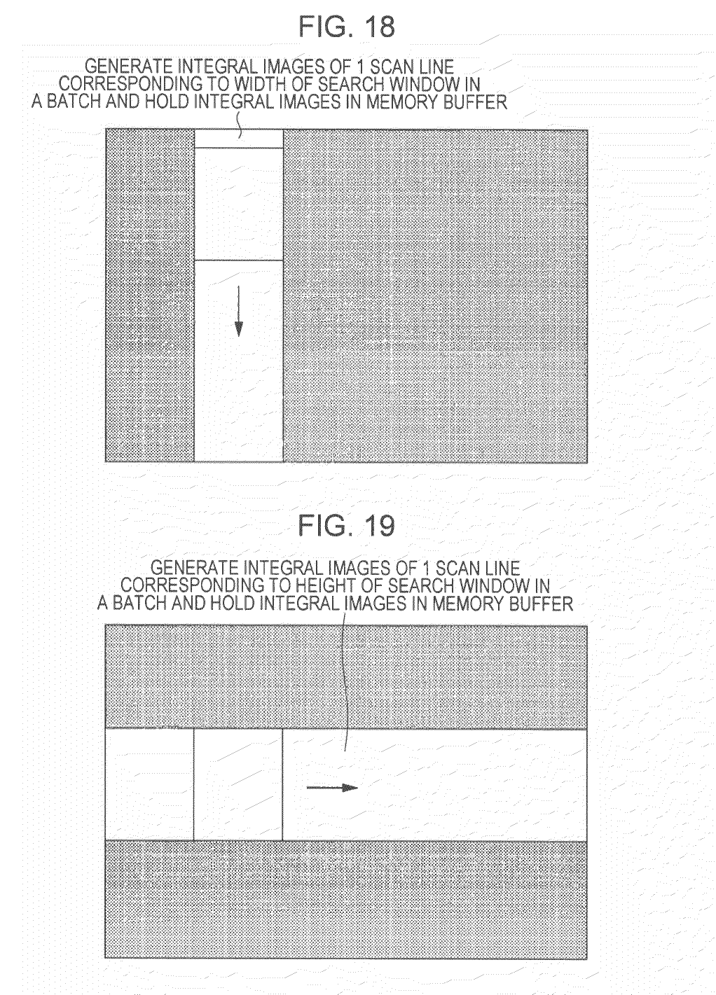

FIG. 18 shows a state in which, if the vertical direction (Y direction) of the input image is the scan direction, integral images of one column corresponding to the width of the search window are generated in a batch on every scan line and held in the memory buffer. In this case, if the width and the height of the input image are respectively set to width and height, the size of the search window is w×h, and one pixel is expressed by n bytes, height×w×n byte of memory capacity is necessary for holding the integral images. For example, if the input image is a VGA screen, the size of the search window is expressed by 32×64 pixels and one pixel is expressed by 4 bytes, the memory capacity is 480×32×4=61,336 bytes, that is, about 62 kilobytes. As compared with the case where the integral images are held with respect to the entire VGA image as shown in FIG. 3, the memory capacity saving effect is obtained.

FIG. 19 shows a state in which, if the horizontal direction (X direction) of the input image is the scan direction, integral images of one row corresponding to the height of the search window are generated in a batch on every scan line and held in the memory buffer. In this case, height×w×n byte of memory capacity is necessary for holding the integral images (one pixel is expressed by n byte). For example, if the input image is a VGA screen, the size of the search window is expressed by 32×64 pixels and one pixel is expressed by 4 bytes, the memory capacity is 640×32×4=163,840 bytes, that is, about 164 kilobytes. As compared with the case where the integral images are held with respect to the entire VGA image as shown in FIG. 3, the memory capacity saving effect is obtained.

FIGS. 14A to 14G and 17 show the method of saving the capacity of the memory buffer for holding the integral images in the case where the rectangle filter for the vertical/horizontal direction is used. Even when the rectangle filter for the oblique direction is used, the capacity of the memory buffer for holding the integral images may be saved, but a different process is necessary in detail.

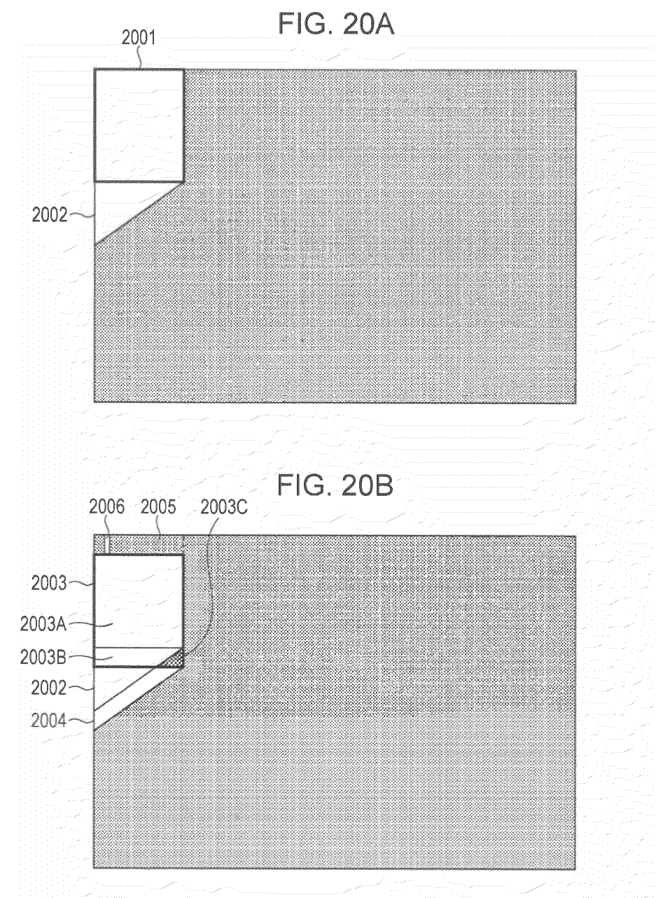

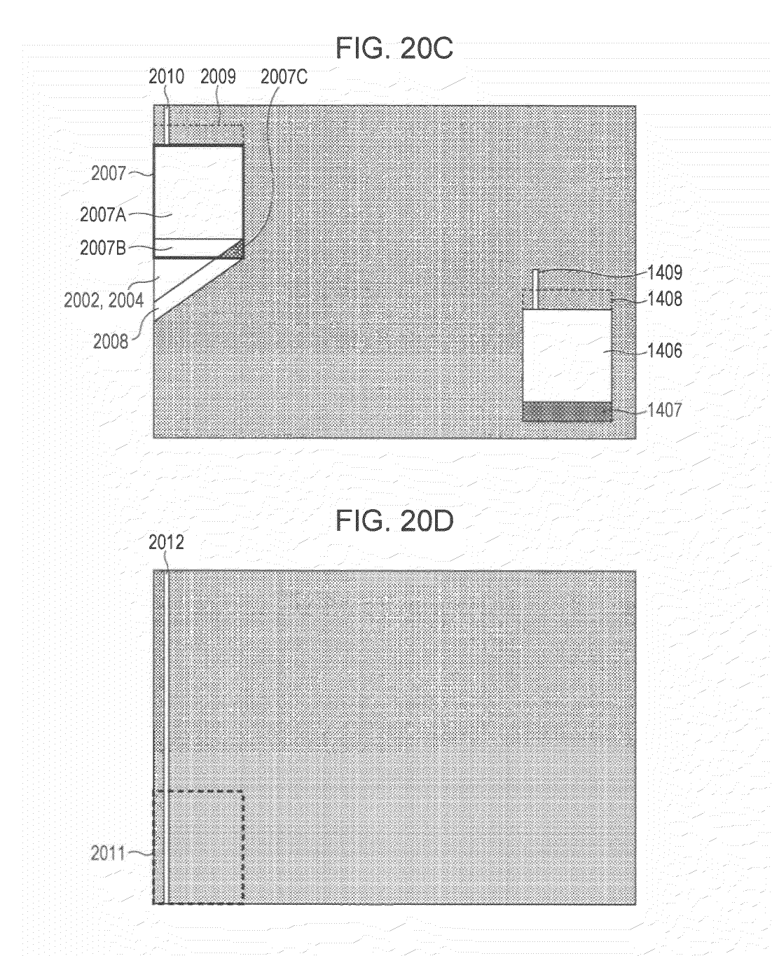

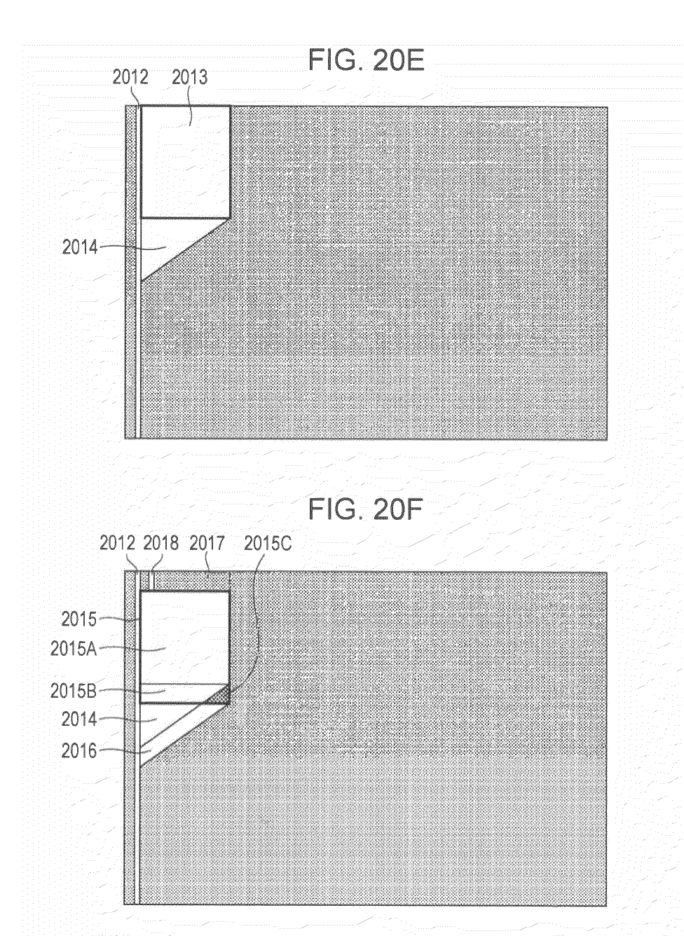

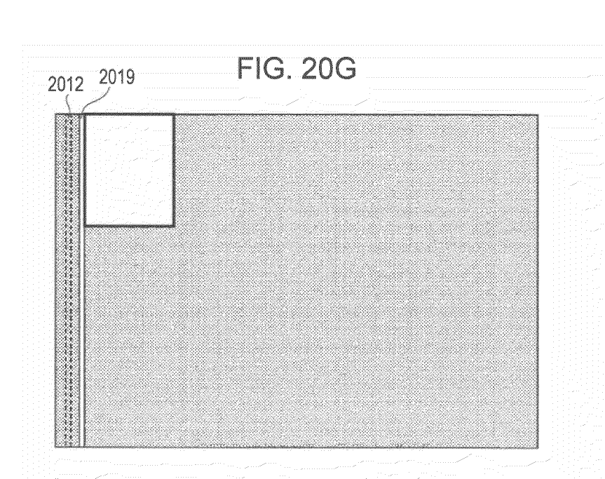

The region, in which the integral pixel value at each scan position of the input is newly calculated, and the region, in which the integral pixel value is held in the memory buffer, of the case of using the rectangle filter for the oblique direction will be described with reference to FIGS. 20A to 20G. The same drawings show an example in which a scan direction is a vertical direction (Y direction). First, the search window is scanned by a predetermined skip width (skip pixels) along the scan line of the vertical direction using an original point (0, 0) as a start position and the generation of the integral image and the calculation of the detection score at every scan position are performed. When the search window reaches the end (the upper limit of the Y coordinate) of the scan direction) of the scan direction, the scan line of the search window is skipped by the predetermined skip width (skip pixels) in the horizontal direction and then scanning is repeated.

First, the scanning unit 13 sets the search window to the original point (0, 0), calculates the integral pixel values by Equations (5) and (6) with respect to all pixel points within the search window region denoted by a reference number 2001 of FIG. 20A, and copies and holds the result in the memory buffer.

When the integral pixel values are calculated, a method of recursively calculating the integral pixel value of the target pixel point by appropriately using the already calculated integral pixel values of the three adjacent pixel points as shown in FIG. 8 and Equation (7) is applied.

In the calculation of the integral pixel value of the rectangle filter in the oblique direction, as shown in FIGS. 7 and 8, it is necessary to obtain the integral pixel values with respect to the pixel point in the isosceles right triangle region having the target pixel point as an apex. To this end, in the process of recursively calculating the integral pixel values with respect to all pixel points within the region 2001, the integral pixel value is calculated with respect to each pixel point within the region 2002 in addition to the region 2001 corresponding to the search window. Since the integral images of the region 2002 are necessary at subsequent scan positions, they are copied and held in the memory buffer along with the integral images of the region 2001.

In the discrimination unit 14, each of the weak discriminators 14₁ to 14_{K} calculates the rectangle feature fᵢ(0, 0) at the scan position using the integral images within the current search window region 2001 held in the memory buffer and the adder 17 weight-adds the rectangle features and outputs the detection score F(0, 0) at the scan position.

Subsequently, as shown in FIG. 20B, the scanning unit 13 moves the search window along the scan line (x=0) in the vertical direction by the predetermined skip width (skip pixels) (that is, y=y+skip). With respect to each pixel point within the region overlapping with the search window 2001 of the preceding scan position, which is denoted by the reference numeral 2003A and each pixel point within the region overlapping with the region 2002, which is denoted by the reference numeral 2003B, in the search window 2003 of the scan position (0, skip) after movement, the calculated integral pixel values are held in the memory buffer. Accordingly, the scanning unit 13 calculates the integral image with respect to only for each pixel within the non-calculated region of the new search window 2003, which is denoted by the reference numeral 2003C, and copies, adds and holds the result in the memory buffer.

In the process of recursively calculating the integral pixel values with respect to all the pixel points within the region 2003C, the integral pixel value is calculated with respect to each pixel point within the region 2004 in addition to the region 2003 corresponding to the search window. The integral images of the region 2004 are copied and held in the memory buffer because they are necessary at subsequent scan positions.

By the movement of the search window, since the integral images of the region denoted by the reference numeral 2005 of FIG. 20B are not necessary for the subsequent calculation of the rectangle feature, the scanning unit 13 discards the integral images of the region 2005 from the memory buffer. However, the region corresponding to one pixel (that is, one pixel line of x=skip−1) (or the pixel line of the pixel width of one pixel or more) just before the next scan line, which is denoted by the reference numeral 2006, is held in the memory buffer. This is because, if the region 2006 corresponding to one pixel line is used as the integral pixel values (see FIG. 8) of the pixel points adjacent to the target pixel point when moving to the next scan line (x=skip), the integral pixel values are recursively calculated by Equation (7).

In the discrimination unit 14, each of the weak discriminators 14₁ to 14_{K} calculates the rectangle feature fᵢ(0, skip) at the scan position using the integral image within the current search window region 2003 held in the memory buffer and the adder 17 weight-adds the rectangle features f(0, 0) and outputs the detection score F(0, skip) at the scan position.

Subsequently, as shown in FIG. 20C, the scanning unit 13 moves the search window along the scan line (x=0) in the vertical direction by the predetermined skip width (skip pixels) (that is, y=y+skip). With respect to each pixel point within the region overlapping with the search window 2003 of the preceding scan position, which is denoted by the reference numeral 2007A, and each pixel position within the region overlapping with the region 2002 or 2004, which is denoted by the reference numeral 2007B, in the search window 2007 of the scan position (0, skip) after movement, the calculated integral pixel values are held in the memory buffer. Accordingly, the scanning unit 13 calculates the integral image with respect to only for each pixel point within the non-calculated region of the new search window 2007, which is denoted by the reference numeral 2007C, and copies, adds, and holds the result in the memory buffer.

In the process of recursively calculating the integral pixel values with respect to all the pixel points within the region 2007C, the integral pixel value is calculated with respect to each pixel point within the region 2008 in addition to the region 2007 corresponding to the search window. The integral images of the region 2008 are copied and held in the memory buffer since they are necessary at subsequent scan positions.

By the movement of the search window, since the integral images of the region denoted by the reference numeral 2009 of FIG. 20B are not necessary for the subsequent calculation of the rectangle feature, the scanning unit 13 discards the integral images of the region 2009 from the memory buffer. However, the region corresponding to one pixel (that is, one pixel line of x=skip−1) (or the pixel line of the pixel width of one pixel or more) just before the next scan line, which is denoted by the reference numeral 2010, is held in the memory buffer. Since the region 2010 corresponding to one pixel line is used as the known integral pixel values when the integral pixel values are recursively calculated at the next scan line (x=skip), the scanning unit 13 holds the region 2010 in the memory buffer.

In the discrimination unit 14, each of the weak discriminators 14₁ to 14_{K} calculates the rectangle feature fᵢ(0, 2skip) at the scan position using the integral image within the current search window region 2007 held in the memory buffer and the adder 17 weight-adds the rectangle features and outputs the detection score F(0, 2skip) at the scan position.

Thereafter, until the search window reaches the end (y=height) of the current scan line (x=0), the processes shown in FIGS. 20B and 20C are repeatedly executed when the search window moves the scan position.

FIG. 20D shows the region in which the integral images are held in the memory buffer when the search window reaches the end (y=height) of the scan line (x=0). Since the integral images within the search window region denoted by the reference numeral 2011 is calculated, but is not necessary for the calculation of the rectangle feature of the next scan line after being used in the calculation of the rectangle feature at the scan position, the scanning unit 13 discards the integral images of the region 2011 from the memory buffer. However, in order to use the region corresponding to one pixel (that is, one pixel line of x=skip−1) (or the pixel line of the pixel width of one pixel or more) just before the next scan line, which is denoted by the reference numeral 2012 as the known integral pixel values when the integral pixel values are recursively calculated at the next scan line, the scanning unit 13 holds the integral images of the region 2012 in the memory buffer.

When the search window reaches the end (y=height) of the scan line (x=0), the scanning unit 13 moves the scan line in the horizontal direction perpendicular to the scan line by the predetermined skip width (skip) (that is, x=skip), sets the search window to the beginning of the scan line (that is, y=0), and begins scanning. While scanning is performed on the scan line (x=skip) so as to calculate the detection score, the scanning unit 13 continuously holds the integral pixel values of the region 2012 held in the process on the preceding scan line (x=0) in the memory buffer. In order to newly calculate the integral pixel value at each scan position on the current scan line (x=skip), the integral pixel value of the target pixel point is recursively calculated by appropriately using the integral pixel value within the region 2012 as the already calculated integral pixel values of the adjacent pixel points.

FIG. 20E shows a state in which the search window is set to the beginning position (y=0) on the next scan line (x=skip). The integral images are calculated with respect to the pixel points within the search window region denoted by the reference numeral 2013. At this time, the integral pixel value of the target pixel point is recursively calculated by appropriately using the already calculated integral pixel values of the three adjacent pixel points within the region 2012 held in the memory buffer as shown in FIG. 8 and Equation (7).

In the process of recursively calculating the integral pixel values with respect to all the pixel points within the region 2013, the integral pixel value is calculated with respect to each pixel point within the region 2014 in addition to the region 2013 corresponding to the search window. The integral images of the region 2014 are copied and held in the memory buffer along with the integral images of the region 2013, since they are necessary at subsequent scan positions.

In the discrimination unit 14, each of the weak discriminators 14₁ to 14_{K} calculates the rectangle feature fᵢ(skip, 0) at the scan position using the integral image within the current search window region 2013 held in the memory buffer and the adder 17 weight-adds the rectangle features and outputs the detection score F(skip, 0) at the scan position.

Subsequently, as shown in FIG. 20F, the scanning unit 13 moves the search window along the scan line in the vertical direction by the predetermined skip width (skip pixels) (that is, y=y+skip). With respect to each pixel point within the region overlapping with the search window 2013 of the preceding scan position, which is denoted by the reference numeral 2015A, and each pixel position within the region overlapping with the region 2014, which is denoted by the reference numeral 2015B, in the search window 2015 of the scan position (skip, skip) after movement, the calculated integral pixel values are held in the memory buffer. Accordingly, the scanning unit 13 calculates the integral image with respect to only for each pixel point within the non-calculated region of the new search window 2015, which is denoted by the reference numeral 2015C, and copies, adds, and holds the result in the memory buffer.

In the process of recursively calculating the integral pixel values with respect to all the pixel points within the region 2015C, the integral pixel value is calculated with respect to each pixel point within the region 2016 in addition to the region 2015 corresponding to the search window. The integral images of the region 2016 are also copied and held in the memory buffer, since they are necessary at subsequent scan positions.

Along with the movement of the search window, since the integral images of the region denoted by the reference numeral 2017 of FIG. 20F is not necessary for the subsequent calculation of the rectangle feature, the scanning unit 13 discards the integral images of the region 2017 from the memory buffer. However, the scanning unit 13 holds the region corresponding to one pixel (that is, one pixel line of x=2skip−1) (or the pixel line of the pixel width of one pixel or more) just before the next scan line, which is denoted by the reference numeral 2018, in the memory buffer, in order to be used as the known integral pixel values when the integral pixel values are recursively calculated at the next scan line (x=2skip).

In the discrimination unit 14, each of the weak discriminators 14₁ to 14_{K} calculates the rectangle feature fᵢ(skip, skip) at the scan position using the integral image within the current search window region 2015 held in the memory buffer and the adder 17 weight-adds the rectangle features and outputs the detection score F(skip, skip) at the scan position.

Thereafter, until the search window reaches the end of the current scan line (x=skip), the process shown in FIG. 20F is repeatedly executed when the search window moves the scan position.

When the search window reaches the end (y=height) of the scan line (x=skip), the scanning unit 13 moves the scan line in the horizontal direction perpendicular to the scan line by the predetermined skip width (skip) (that is, x=x+skip=2skip), sets the search window to the beginning of the scan line (that is, y=0), and begins scanning. While scanning is performed on the scan line (x=2skip), the scanning unit 13 continuously holds the integral image of the region 2019 held in the process on the preceding scan line (x=skip) in the memory buffer. In order to newly calculate the integral pixel value at each scan position on the current scan line (x=2skip), the integral pixel value of the target pixel point is recursively calculated by appropriately using the integral pixel values within the region 2019 as the integral pixel values of the adjacent pixel point. Since the (above-described) integral image within the region 2012 held upon scanning on the scan line just before the preceding scan line is not necessary by the movement of the scan line, the scanning unit 13 discards the integral image within the region 2012 from the memory buffer.

FIG. 20G shows a state in which the search window is set to the beginning position (y=0) on the next scan line (x=2skip). On the scan line, the same processes as those shown in FIGS. 20E and 20F are repeatedly executed. When the scan position reaches the end (y=height) of the scan line (x=2skip), the scan line is moved in the horizontal direction perpendicular to the scan line by the predetermined skip width (skip) (x=x+skip). Then, until the scan line reaches the end (x=width) of the input image, the same processes as those shown in FIGS. 20E to 20G are repeatedly executed.

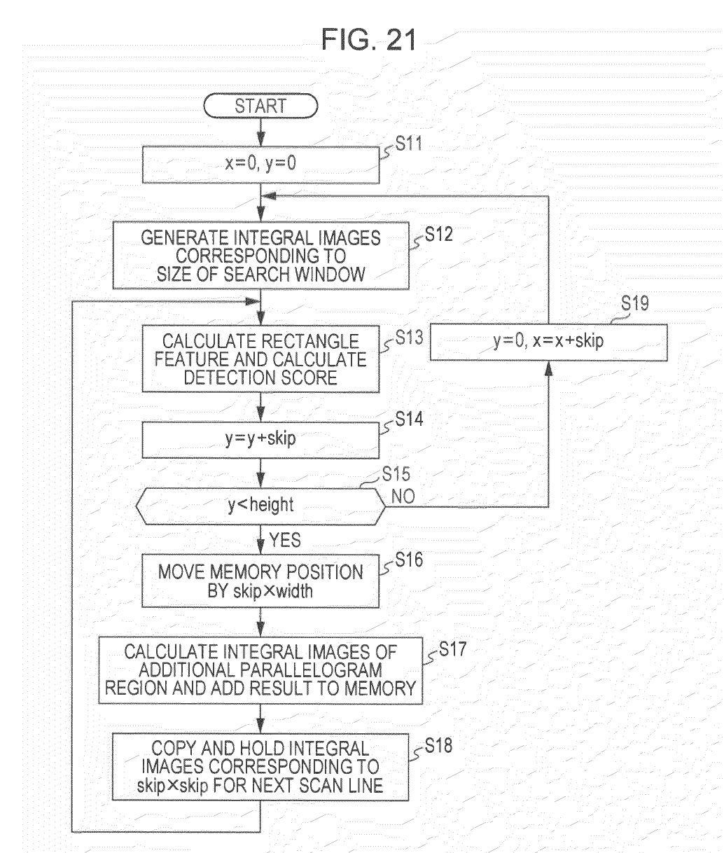

FIG. 21 shows a flowchart of a sequential process of calculating a rectangle feature by a rectangle filter for an oblique direction using an integral image. As shown in FIG. 14, a scan direction is a vertical direction (Y direction) and a movement amount of a scan position per one scan of each XY direction is skip (the number of pixels).

First, as shown in FIG. 20A, the scanning unit 13 sets a scan position (x, y) to an original point (0, 0) and begins to scan a search window on a scan line of x=0 (step S11).

The scanning unit 13 generates integral images corresponding to the size of the search window set at the current scan position (x, y) (step S12) and holds the integral image in the memory buffer for the integral image. With respect to the region in which the calculated integral pixel values in the search window are held in the memory buffer, these integral images are used. When the integral images are generated, the integral pixel values are recursively calculated by appropriately using the integral pixel values of the already calculated adjacent pixel points.

The scanning unit 13 applies the search window to the current scan position (x, y) on the input image and crops the window image from the memory buffer for the input image. In the discrimination unit 14, when the integral images are read from the memory buffer for the integral image, each of the weak discriminators 14₁ to 14₄ rapidly calculates the rectangle feature fᵢ(x, y) of the rectangle filter (the filter for the oblique direction) (see FIG. 6). Then, the adder 17 weight-adds each rectangle feature fᵢ(x, y) and calculates a detection score at the current scan position (x, y) (step S13).

If the calculation of the rectangle feature at the current scan position (x, y) and the calculation of the detection score are completed in the discrimination unit 14, the scanning unit 13 moves the scan position. That is, the scanning unit 13 adds a predetermined skip width (skip) to the y coordinate of the current scan position (step S14) and moves the scan position along the scan line, that is, the Y direction.

At this time, the scanning unit 13 checks whether the y coordinate of the scan position is less than the height of the input image, that is, whether the scan position does not reach the end of the current scan line (step S15).

If the scan position does not reach the end of the current scan line (Yes of step S15), the scanning unit 13 updates the region in which the integral pixel values are held in the memory buffer for the integral image and performs the calculation of the integral pixel values. In detail, the region of the search window to hold the integral images is moved by skip×width (step S16).

At this time, the scanning unit 13 calculates the integral pixel value with respect to only for each pixel point within the region (for example, the region denoted by the reference numeral 2003C of FIG. 20B) in which the integral pixel values are not still calculated and which is newly included in the search window, and adds and holds the result in the memory buffer (step S17). At this time, the integral pixel values are recursively calculated by appropriately using the integral pixel values of the already calculated adjacent pixel points. In the process of recursively calculating the integral pixel values with respect to all pixel points within the added region, the integral pixel value is calculated with respect to each pixel point within a necessary region (for example, the parallelogram region denoted by the reference numeral 2004 of FIG. 20B) other than the search window.

Since the region (for example, the region denoted by the reference numeral 2006 of FIG. 20B) corresponding to one pixel (that is, one pixel line of x=skip−1) (or the pixel line of the pixel width of 1 pixel or more) just before the next scan line is used in the recursive calculation of the integral pixel values at the next scan line, the scanning unit 13 holds the integral pixel value of each pixel point within the region in the memory buffer (step S18). The integral pixel values of the region (for example, the region denoted by the reference value 2005 of FIG. 20B) deviated from the search window by the movement of the search window are discarded from the memory buffer.

When the scan width (skip) exceeds the width w of the search window, in step S18, instead of the above process, a process of calculating the integral pixel values corresponding to skip×skip pixels and copying the integral pixel values in the memory buffer is performed.

When the scan position (x, y) reaches the end of the current scan line (No of step S15), the scanning unit 13 moves the search window to the next scan line. That is, the scanning unit 13 returns the y coordinate position of the search window to 0, adds the predetermined skip width (skip) to the x coordinate position (step S19). Then, returning to step S12, the same processes as above-described process is repeatedly executed on the next scan line.

Even in the case of using the rectangle filter for the oblique direction, when only the integral images of the region corresponding to the size of the search window as shown in FIGS. 20A to 20G and the region necessary for the recursive calculation of the integral pixel values are held in the memory buffer instead of the entire input image, the capacity of the necessary memory buffer is significantly reduced similarly to the case of using the rectangle filter for the vertical/horizontal direction (see FIGS. 15 and 16).

Even in the case of using the rectangle filter for the oblique direction, similarly to the case of using the rectangle filter for the vertical/horizontal direction (see FIGS. 18 and 19), a modified example in which the integral images corresponding to the width or the height of the search window at every scan line are generated in a batch and held in the memory buffer may be considered.

The present application contains subject matter related to that disclosed in Japanese Priority Patent Application JP 2010-043657 filed in the Japan Patent Office on Mar. 1, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
a scanning unit configured to scan a search window on an image to be detected; and
a discrimination unit configured to apply one or more rectangle filters for detecting a desired object to an image of the search window at each scan position so as to calculate one or more rectangle features and to discriminate whether or not the object is detected based on the obtained one or more rectangle features,
wherein the scanning unit generates integral images corresponding to a size of the search window at every scan position and holds the integral images in a predetermined memory buffer, and
wherein the discrimination unit calculates the rectangle features with respect to the image of the search window at each scan position using the integral images held in the memory buffer.

2. The image processing device according to claim 1, wherein the scanning unit discards integral images of a region, which is not necessary at a subsequent scan position, from the memory buffer when moving the scan position, calculates integral images of a region newly added to the search window, and adds and holds the calculated integral images in the memory buffer.

3. The image processing device according to claim 2, wherein the scanning unit continuously holds integral images of a region adjacent to the region newly added to the search window at the subsequent scan position in the memory buffer when moving the scan position, and the integral images of the region newly added to the search window are recursively calculated using the integral images of the adjacent region held in the memory buffer.

4. The image processing device according to claim 2, wherein the scanning unit continuously holds integral images of a pixel line of a pixel width of one pixel or more just before a next scan line in the memory buffer when moving the scan position on a current scan line, and the integral images of the region of the search window are recursively calculated using the held integral images of the pixel line at each scan position on a next scan line.

5. The image processing device according to claim 1, wherein the scanning unit generates integral images of a region of one column corresponding to a width of the search window at every scan line when performing scanning on the image to be detected in a vertical direction.

6. The image processing device according to claim 1, wherein the scanning unit generates integral images of a region of one row corresponding to a height of the search window at every scan line when performing scanning on the image to be detected in a horizontal direction.

7. An image processing method comprising the steps of:
scanning a search window on an image to be detected, generating integral images corresponding to a size of the search window at every scan position, and holding the integral images in a predetermined memory buffer; and
applying one or more rectangle filters for detecting a desired object to an image of the search window at each scan position, calculating one or more rectangle features using the integral images held in the memory buffer, and discriminating whether or not the object is detected based on the obtained one or more rectangle features.

8. A computer program described in a computer-readable format such that a process of detecting a desired object from an image to be detected is executed on a computer, the computer program allowing the computer to function as:
a scanning means configured to scan a search window on the image to be detected, to generate integral images corresponding to a size of the search window at every scan position, and to hold the integral images in a predetermined memory buffer; and
a discrimination means configured to apply one or more rectangle filters for detecting the desired object to an image of the search window at each scan position, to calculate one or more rectangle features using the integral images held in the memory buffer, and to discriminate whether or not the object is detected based on the obtained one or more rectangle features.
